(19) United States
(12) Patent Application Publication
(10) Pub. No.: US 2011/0161119 A1
(43) Pub. Date: Jun. 30, 2011

(54) RISK ASSESSMENT AND CONTROL, INSURANCE PREMIUM DETERMINATIONS, AND OTHER APPLICATIONS USING BUSYNESS

(75) Inventor: Dean Collins, Manchester, CT (US)

(73) Assignee: THE TRAVELERS COMPANIES, INC., Hartford, CT (US)

(21) Appl. No.: 12/978,535

(22) Filed: Dec. 24, 2010

Related U.S. Application Data
(60) Provisional application No. 61/290,066, filed on Dec. 24, 2009.

(51) Int. Cl. G06Q 40/00

(52) U.S. Cl. 705/4

(57) ABSTRACT

A “busyness” metric is determined for various different objects, such as businesses, roads, vehicles, buildings, locations, transportation systems, communication systems, devices, equipment, and/or systems, using various sensing and/or other technologies. The busyness metric may be used for a broad range of applications, such as assessing and controlling insurance risk, determining insurance premiums, prioritizing tasks, travel, navigation, advertising, and other purposes.

### CROSS-REFERENCE TO RELATED APPLICATIONS

This application claims benefit and priority under 35 U.S.C. §119(e) to U.S. Provisional Patent Application No. 61/290,066 titled “RISK ASSESSMENT, INSURANCE PREMIUM DETERMINATIONS, AND OTHER APPLICATIONS USING BUSYNESS” and filed Dec. 24, 2009, the entirety of which is hereby incorporated by reference herein.

### BACKGROUND

Insurance companies assess risk and calculate premiums for insurance products based on many factors and often utilize complex mathematical equations and models to do so. The accuracy with which these companies are able to assess, manage and/or mitigate risk and properly price their premiums has great impact on their profitability and ultimate success. Yet despite the importance of these functions to the insurance industry, previous practices have failed to take into account information that may greatly increase accuracy and reliability of risk assessment and premium determinations and the effectiveness and benefits of risk control measures.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a functional block diagram of a process according to some embodiments;

FIG. 3 is a block diagram of a system according to some embodiments;

FIG. 4 is a perspective diagram of a system according to some embodiments;

FIG. 5 is a block diagram of a system according to some embodiments;

FIG. 6 is a flow diagram of a method according to some embodiments;

FIG. 7 is a flow diagram of a method according to some embodiments;

FIG. 8 is a diagram of an exemplary risk matrix according to some embodiments;

FIG. 9 is a is a flow diagram of a method according to some embodiments;

FIG. 10 is a block diagram of an apparatus according to some embodiments;

FIG. 11A and FIG. 11B are perspective diagrams of exemplary data storage devices according to some embodiments;

FIG. 12 is an example graph according to some embodiments;

FIG. 13 is an example table according to some embodiments; and

FIG. 14 is an example interface according to some embodiments.

### DETAILED DESCRIPTION

### I. Introduction

Embodiments described herein are descriptive of systems, apparatus, methods, and articles of manufacture for risk assessment and premium determinations. In some embodiments, for example, the historic, perceived, actual, and/or predicted “busyness” of an object (an “object” may comprise, for example, any type, quantity, and/or configuration of things, people, animals, vehicles, machinery, locations, individuals, properties, networks, pathways, entities, businesses, etc.) may be utilized to provide enhanced risk assessment, risk control, and/or premium determinations. As utilized herein, the term “busyness” may generally refer to a measure of activity of an object (e.g., how “busy” the object is, e.g., traffic associated with an object, such as foot or vehicle traffic, or how many people or vehicles occupy a given area). The busyness of many different types of objects may, according to some embodiments, be utilized to assess risk and/or calculate insurance premiums. For example, when there are many people (and/or human-controlled vehicles or machines) located in a given area, there is a higher likelihood that they may interfere with, endanger (e.g., bump into), or otherwise affect each other and cause injury or losses, or that any given person/vehicle will be injured/damaged or affected by a hazard in the area, than if there were only a few people and/or vehicles.

In some embodiments, busyness may be related to “people/vehicle/item density”, and/or “interaction/distraction”, and/or other factors, components, or parameters which are discussed herein. The “people/vehicle/item density” (or crowdedness) component may be indicative of the number of people, vehicles, items, objects, equipment, devices, or the like, at a given location or area at a given point in time (which may be viewed as a static parameter). A dynamic aspect of “people/vehicle/item density” component may be the movement of (or change in number of) people, vehicles, items, objects, equipment, devices, or the like, passing through, by, or near, a given location or area over a given period of time, which may also be referred to as a “traffic/throughput” busyness component (which may be viewed as the rate of change (or derivative) of the “people/vehicle/item density” component).

The “busyness” of a commercial business (or store), for example, may be expressed in terms of how many people enter the store on a given day or during a given period of time (whether or not any goods are sold), and/or in terms of how many people are in line at the checkout line of the store at a given time or during a given period of time, and/or how many people are in a given aisle (or a portion of a given aisle) of the store at a given time or during a given period of time.

The busyness of a given roadway may be expressed in terms of how many automobiles, pedestrians, and/or bicycles are on the road at a given time or during a given period of time. Accordingly, a vehicle driving down a road having a high number of automobiles, pedestrians, and/or bicycles nearby (i.e., having a high busyness level or index) presents a different risk environment than one traveling alone on a rural highway (e.g., the “people/vehicle/item density” component).

The “busyness” of an automobile, for example, may be expressed in terms of how many people and/or passengers are in the vehicle at any given time or over any given period the (e.g., the “people/vehicle/item density” component), and/or how many other vehicles are on the same road in the same area at the same time (e.g., the “interaction/distraction” component). The busyness object may also be the person operating an object, for example, the driver of a car may have a high busyness level if the car is crowded with people or there are many other cars on the road (e.g., the “human interaction/distraction” component), which may correlate to a high level of risk. Similarly, a person (or worker) that has a high busyness level such as too many interactions or distractions or is overworked (too many assignments/tasks to perform over a given period), may be more likely to make mistakes (thus an Errors & Omissions (E&O) risk), or may make an error that causes physical harm to the worker (e.g., a drill press operator required to look at a video screen and at the work piece simultaneously).

The “Interaction/distraction” busyness component may affect or adjust the people/vehicle/item density component and/or the traffic/throughput component or may by itself affect or adjust the overall busyness of an area. In either case it may comprise various levels and/or categories. Interaction may be human interaction and be descriptive of how many humans/organisms are interacting with an object (e.g., things, items, devices, hazards, etc.) at any given time or during any given period (e.g., human interaction as it relates to the busyness of a person or an object), and/or how many objects (e.g., things, items, devices, hazards, etc.) and/or other humans a person is interacting with (or tolerating) at any given time (or during any given period) when doing a given job or activity (e.g., human interaction as it relates to how busy the person is; e.g., distraction level). For example, other people in the vehicle may be a distraction or represent a greater risk—e.g., a full versus empty bus, a car full of individuals rather than a lone commuter. A person's distraction level may also be affected by cultural, age-related, gender-related, and relationship-based factors. For example, four unrelated people in a large room may each keep to themselves and stay in different areas, whereas people who are related or friends, may tend to stay physically closer to each other or interact more with each other, which may change the risk environment, such as a mother watching her children, or a family traveling together at an airport or bus station. Distraction level may also be related to the level of audio and/or visual noise that a person is exposed to, or even to the magnitude and/or type of olfactory (i.e., smell-related) distractions that may be present in the person's environment. In some embodiments, the interaction/distraction component may also refer to inanimate object-to-object interaction or distraction, where there may be a greater risk of loss when computer systems may fail or react more slowly when required to interact with other objects quickly or faster than one object is capable of adequately processing information and making decisions or certain hazards are present or for other reasons inanimate objects are negatively impacted by interaction or distraction.

Hazards may be considered a part of the “Human interaction/distraction” busyness component (as suggested above), or may be considered a separate component that affects, impacts or adjusts the risk situation for a given busyness level. If considered as a separate component, hazards may have a factor or level themselves which can be factored into the busyness level or considered separately with busyness to affect the ultimate risk assessment (and thus premium determination). Hazards may include anything affecting a person's or object's environment that increases the risk of loss, such as certain types of weather (e.g., sun, wind, rain, ice, snow, etc.), pot holes, wet floors, poor lighting, uneven floors or walking surfaces, broken or unmaintained equipment, lack of safety guards or devices, or any other hazard that increases the risk of loss.

“People/vehicle/item density” busyness may, for example, according to some embodiments, be descriptive of how many people/vehicles/items occupy an area independent of whether or not they interact with each other or are distracted by each other. In that case, the interaction/distraction component may be an additional component to the people/vehicle/item density component to help determine overall busyness of an person, object or place.

It may be beneficial, for example, for an insurance policy on an automobile to be structured to take into account the busyness of specific roads on which a driver of the automobile frequently travels (e.g., take into account busyness of objects other than those being insured). While standard automobile insurance policies are written to take into account the added risk associated with each generic mile driven by an automobile (e.g., it is known that insurance premiums may be at least partially based on how many miles are driven by the automobile on an annual basis), no measure of the busyness of other related objects (such as the road, i.e., how many other cars are on the road at the same time) associated with the policy are taken into account. Current usage-based insurance programs measure and consider usage at a more detailed level than standard conventional policies; but their measurements remain focused on the insured, not their busyness or the busyness of the surrounding environment(s) in which the insured operates. Embodiments described herein may generally improve the risk assessment (and thus profitability) of such an automobile policy (as well as other types of insurance or investment products) by inserting a metric descriptive of the busyness of these other objects and/or a more detailed busyness metric descriptive of the insured object itself, into the risk assessment and/or pricing routines utilized to structure such policies, and/or the risk control services and/or initiatives that may be provided to the customer.

According to some embodiments, systems, apparatus, methods, and articles of manufacture of the present disclosure may comprise receiving a request by a customer for an insurance product, determining an object (such as an object indicative of risk) associated with the insurance product, determining a busyness metric of the object, and/or determining, based at least in part on the busyness metric, a risk rating of the insurance product. Insurance products may include any type of insurance products or services, including but not limited to property and casualty insurance (including but not limited to business/commercial insurance, personal insurance, auto/motor, home, personal property, real property, watercraft, aircraft, spacecraft, general liability, professional, D&O, E&O, employer liability, business torts, surety and fidelity bonds, product liability, or any other type of insurance coverage).

In some embodiments, the object(s) for which busyness data is gathered and/or analyzed for pricing an insurance product may be different from the object covered by the insurance product. In the case of an insurance policy for a business establishment, for example, factors such as age of the building, type of construction, type of heating system, and whether an active fire suppression system is installed are typically taken into account (i.e., attributes of the object being insured). Embodiments herein describe also or alternatively taking into account, for example, the busyness of adjacent businesses, adjacent sidewalks, and/or an adjacent and/or nearby parking garage (e.g., objects other than those being insured). In such a manner, insurance policies may more appropriately take into account factors that may affect risk.

In some embodiments, busyness of such objects as sidewalks, stores, roads, and/or other locations may be determined utilizing technologies capable of locating cellular telephones (and/or other devices) in such areas (e.g., Global Positioning System (GPS) or other satellite technology, cell-tower triangulation, and/or self-reporting or social networking mechanisms or tools such as the “check-in” feature of Foursquare™ (www.foursquare.com) offered by Foursquare Labs, Inc. of New York, N.Y., and/or the “Places” feature of Facebook™ (www.facebook.com) of Palo Alto, Calif., and/or Twitter™ where people can broadcast (or “tweet”) their location to their “followers” via text/SMS, email or other network, and/or utilizing Radio Frequency Identification (RFID) devices to monitor traffic levels (e.g., RFID-enabled lift tickets may allow for the tracking of ski lift traffic—i.e., how many skiers are actually utilizing the lift, as opposed to enjoying a lodge and/or other areas of a resort).

In some embodiments, data may be obtained from a vendor such as a payroll vendor for the payroll data for a given business. In some embodiments, payroll may be utilized as a busyness indicator on a person level and/or at a company aggregate level, and viewed over short time periods, e.g., days or weeks, to create a people time density. In some embodiments, payroll data may be correlated to the busyness level and determine whether the payroll level is causing more or less risk or no change to the risk profile for the business.

Some embodiments comprise determining, based at least in part on the determined risk rating of the insurance product, an insurance premium of the insurance product. Embodiments may also or alternatively comprise selling, after the determining of the insurance premium of the insurance product, the insurance product to the customer, determining (e.g., after the selling of the insurance product to the customer) a claim made on the insurance product, determining (e.g., after the determining of the claim made on the insurance product) a value of a busyness parameter that is associated with the claim made on the insurance product, and/or updating, based on the value of the busyness parameter that is associated with the claim made on the insurance product, one or more of (i) the busyness metric of the risk indicative object, (ii) the risk rating of the insurance product, and/or (iii) the insurance premium of the insurance product. In such a manner, for example, a feedback loop may be established that iteratively increases the accuracy of any calculations and/or models that utilize the busyness metric as a factor.

In some embodiments, busyness may be used in connection with rooms intended for public gatherings that have capacities expressed in people (i.e. “The capacity of this room is 103 people by order of the Fire Marshal”), and also boats, or other water vessels having maximum safe capacities (“Maximum number of people for this vessel is 60”). The busyness level may be also correlated to the stated capacity to determine whether an object has a high risk level. For example, the frequency at which a given object, such as a hotel or ferry boat, or a sub-object, such as a function room in a hotel, have a number of people that meets or exceeds or comes close to capacity, may correspond to the risk assessment for the object being insured. Also, areas labeled as “high traffic areas” by builders based on an understanding of foot and/or vehicle traffic, building/construction design and/or layout, may be places where busyness monitoring occurs to more accurately assess the risk of these areas.

In some embodiments, the risk indicative object (e.g., which may comprise an object other than that being insured) may comprise a “transportation conduit object” comprising, for example, one or more of: (i) a path or trail, (ii) a sidewalk, (iii) a road, (iv) an intersection of two or more roads, (v) a water channel, (vi) an High Occupancy Vehicle (HOV) lane of a road, (vii) a slow vehicle lane of a road, (viii) an exit lane or ramp of a road, (ix) an entrance ramp, lane, or merge area of a road, (x) a railroad crossing, (xi) aviation airspace/airways (for flying vehicles, planes, helicopters, etc.), (xii) a bridge, (xiii) a tunnel, (xiv) a mall, (xv) a concourse, (xvi) a hall, (xvii) a stairwell, (xviii) an escalator, (xix) a landing, (xx) an aisle, and (xxi) a skyway. As utilized herein, the term “transportation conduit object” may generally refer to any type or configuration of pathway that is utilized for transportation. Such objects may generally refer to a plurality of interconnected locations defined by the particular pathway and/or type of pathway (e.g., all of the specific points along a railroad track, when taken together, may define a specific transportation conduit object). In some embodiments, such objects and/or pathways may be subdivided as is or becomes practicable. A particularly treacherous down-hill segment of a mountain highway, or a section of road at a busy intersection, for example, may each comprise a single transportation conduit object—that may in fact also be part of a larger transportation conduit object (e.g., the ten (10) mile stretch of the same highway or road that connects two cities). In some embodiments, as the level of subdivision of a transportation object increases, it may overlap in definition with and/or become a “location object”.

In some embodiments, the risk indicative object may comprise a “location object” comprising, for example, one or more of: (i) a business location, (ii) a parking lot, (iii) a parking garage, (iv) a retail store, (v) a doctor's office, (vi) a bank, (vii) a mall (or a portion thereof such as a “food court”), (viii) a hairdresser or barber shop, (ix) a restaurant, (x) a supermarket, (xi) a convenience store, (xii) a marina or harbor, (xiii) a train or bus station, (xiv) a bridge, (xv) a tunnel, (xvi) an airport, (xvii) a toll booth or plaza, (xviii) a dock, (ix) a ferry, (xx) public or municipal building, (xxi) a historic site or building, (xxii) a public landmark, (xxiii) a hospital, (xxiv) a library, (xxv) a museum, (xxvi) a national or state park, (xxvii) a public beach, (xxviii) a town square or green, (xxix) a public fairground, (xxx) a theatre, (xxxi) a sports facility or stadium, (xxxii) a racetrack, (xxxiii) an amusement park, (xxxiv) an arcade, (xxxv) a beach, (xxxvi) a resort, (xxxvii) a nightclub, (xxxviii) a golf course, (xxxix) a residential location or house, and (xxxx) a casino. As utilized herein, the term “location object” may generally refer to any specific, identifiable location and/or type of location. A specific restaurant offering a particular type of cuisine may comprise a single location object, for example, and/or all restaurants serving the same type of cuisine may comprise a single location object.

In some embodiments, the risk indicative object may comprise a “communication conduit object” comprising, for example, one or more of: (i) a communication and/or data network, (ii) a website, (iii) an Internet Service Provider (ISP), (iv) a telephone queue, (v) an Interactive Voice Response Unit (IVRU) queue, and (vi) a cellular telephone network. As utilized herein, the term “communication conduit object” may generally comprise any type or configuration of pathway that is utilized for communications that is or becomes known or practicable. In some embodiments, such pathways may comprise substantially electronic, optical, and/or wireless (e.g., Wi-Fi®) pathways. In some embodiments, communication conduit objects may exclude transportation conduits.

In some embodiments, the risk indicative object may comprise a “mechanical object” comprising one or more of: (i) a train, (ii) a bus, (iii) an elevator, (iv) an escalator, (v) a drawbridge, (vi) a water transport lock, (vii) a security lock, (viii) a cellular telephone network tower or repeater, (ix) a router, (x) a web server and/or other computerized device, (xi) a file server, (xii) an IVRU, (xiii) a railroad crossing warning signal or gate, (xiv) a street light, (xv) a traffic light, (xvi) a vehicle, (xvii) a bicycle, (xviii) construction machinery and/or equipment, (xix) agricultural equipment and/or machinery, (xx) manufacturing equipment and/or machinery, and (xxi) tools. As utilized herein, the term “mechanical object” may generally comprise any type or configuration of device and/or machine that is or becomes known or practicable.

According to some embodiments, the object indicative of risk may be determined based on historic location data of the customer, current/real-time location data of the customer, predicted location data of the customer, based on identifying information provided by the customer, based on demographic data, empirical analysis (e.g., of insurance claim data), social networking data (e.g., number of “friends” and/or characteristics thereof), and/or any combination thereof.

In some embodiments, the busyness metric may be determined by transmitting information indicative of the risk indicative object to a server storing past, present and/or future predicted information descriptive of the busyness associated with the risk indicative object and/or receiving (e.g., from the server) one or more numerical values that define the busyness metric. The busyness metric may, for example, be provided by and/or purchased from a third-party (e.g., an entity other than an insured/policy holder or an insurer) such as a commercial aggregator or other third party data provider of busyness data.

According to some embodiments, an insurer may comprise an entity that aggregates and/or calculates busyness data. In some embodiments, for example, the determining of the busyness metric may comprise storing data descriptive of at least one of historical information descriptive of the busyness associated with the risk indicative object, current/real time information descriptive of the current busyness associated with the risk indicative object, and predicted information descriptive of the busyness associated with the risk indicative object, analyzing the stored data, and/or calculating, based on the analysis of the stored data, the busyness metric.

In some embodiments, one or more specialized machines such as a computerized processing device, a server, a remote terminal, and/or a customer device may implement the various practices described herein. A computer system of an insurance company may, for example, comprise various specialized computers that interact to perform risk assessments, insurance premium calculations, and/or insurance product sales as described herein.

### II. Processes/Systems

A. Overview

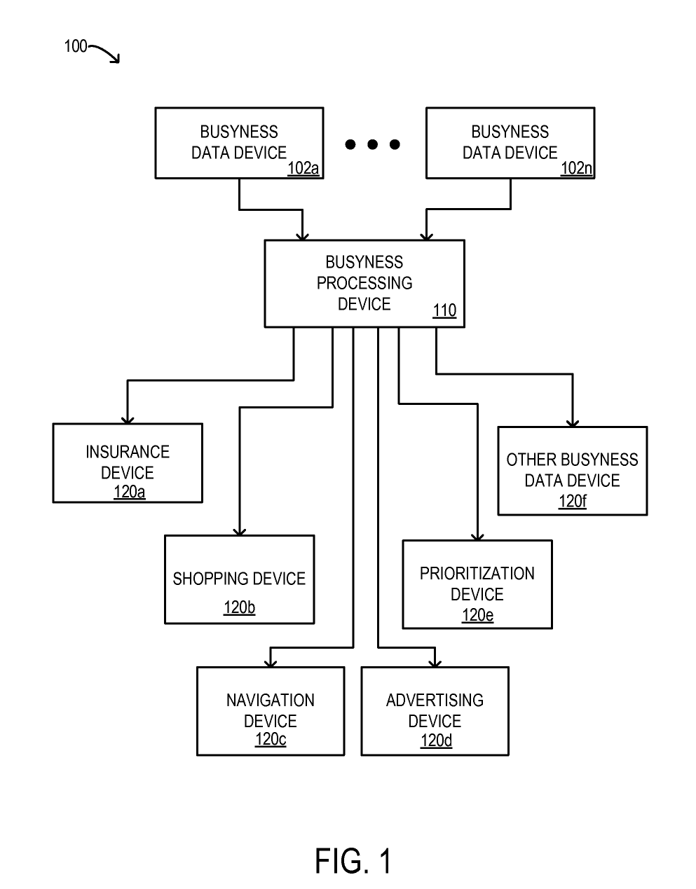

Turning first to FIG. 1, a block diagram of a system 100 according to some embodiments is shown. In some embodiments, the system 100 may comprise a plurality of busyness data devices 102a-n. The busyness data devices 102a-n may collect and/or store data descriptive and/or indicative of a level of busyness of one or more objects. The busyness data devices 102a-n may, for example, comprise one or more sensors (e.g., web-based cameras and/or motion sensors, or other busyness sensors—discussed more hereafter), databases, and/or third-party data and/or sensing devices configured and/or situated to determine busyness data. In some embodiments, the busyness data gathered and/or stored by one or more of the busyness data devices 102a-n can be queried, collected, sensed, looked-up, and/or otherwise obtained and/or determined by a busyness processing device 110. The busyness processing device 110 may, for example, comprise one or more computers and/or servers in communication with the busyness data devices 102a-n. The busyness processing device 110 may, in some embodiments, offer the busyness information for sale and/or subscription to various entities, for various purposes.

According to some embodiments for example, the system 100 may also or alternatively comprise one or more of an insurance device 120a, a shopping device 120b, a navigation device 120c, an advertising device 120d, a prioritization device 120e, and/or any other busyness data device 120f. Any or all busyness data collected, aggregated, and/or processed by the busyness processing device 110, for example, may be provided to any or all of the insurance device 120a, the shopping device 120b, the navigation device 120c, the advertising device 120d, the prioritization device 120e, and/or the other busyness data device 120f.

The insurance device 120a may comprise, for example, a device (or system) owned and/or operated by or on behalf of or for the benefit of an insurance company. The insurance company may utilize busyness information, in some embodiments, to manage, analyze, design, rate, price, and/or otherwise structure insurance products. Busyness information may, for example, enhance the accuracy of insurance risk assessments and thus lead to more profitable and/or reliable insurance product offerings. In some embodiments, busyness information may be utilized to provide discounted premiums and/or other incentives or benefits to insurance customers. An insurance company may provide a discount to a customer willing to allow the insurer (or a third party benefiting the insurer) access to busyness information (such as number of people in an insured business or insured vehicle, or the location of an insured vehicle which may be considered personal in nature), for example, and/or may utilize busyness information to note that a municipality qualifies for a reduced insurance rate and/or risk rating (or should be charged a higher rate due to an increased risk rating).

The shopping device 120b may, according to some embodiments, comprise a device (or system) that is utilized to incorporate busyness information into shopping-related decision making processes. Consumers may utilize busyness information to determine when the best times to visit retail and/or online merchants may be (e.g., the busiest times and/or the quietest times), and/or to determine which merchants to visit (e.g., a consumer may decide to visit a less crowded and therefore presumably less “laggy” website to make a purchase and/or may determine which restaurant to visit based on how crowded it is and/or how long the current or expected wait is). Retailers and/or other merchants may, in some embodiments, utilize busyness information to affect pricing, stocking, and/or staffing decisions.

The navigation device 120c may, according to some embodiments, comprise a device (or system) configured to make and/or facilitate navigational decisions based on busyness. Known or expected busyness/traffic levels of certain roadways at certain times, for example, may be utilized to plot routes that are likely to be the most efficient (e.g., to avoid traffic congestion; e.g., such as may be facilitated by a map and/or device enabled by NAVTEQ™ of Chicago, Ill.). The advertising device 120d may comprise a device (or system) utilized by and/or on behalf of one or more advertising entities. Advertisers may, for example, utilize busyness information to structure, place, analyze, and/or otherwise manage advertisements and/or advertising campaigns—such as prioritizing which advertisements get displayed and/or when or where (e.g., in busy areas). Similarly, the prioritization device 120e may comprise a device (or system) that otherwise makes and/or facilitates prioritization decisions based on busyness. The order of performing errands or tasks may be prioritized based on busyness of the objects needed to visit, for example, go to the cleaners first then do groceries, which is very crowded currently, or which rides to go on when at an amusement park. In some embodiments, overall and/or “blended” busyness may be utilized for navigation and/or prioritization. While a first road may be more busy than a second road, for example, the first road may allow a person to arrive at a drycleaners during a time of expected low activity at the drycleaners, while the second and less busy road would not. Thus, the overall busyness of a route, itinerary, and/or schedule may be determined and/or managed (e.g., to reduce expected and/or relative risk). Similarly, while a particular time can be established at which an amusement park ride will be less busy (e.g., utilizing the Fastpass® service offered by the Walt Disney® Company of Burbank, Calif.), some embodiments may combine items on an itinerary such as the ride and having lunch, to determine that the ride should be visited at a different (and perhaps even busier) time, e.g., to avoid and/or reduce busyness at a selected lunch establishment (for which busyness may, for example, be a more difficult and/or time-consuming affair than a busy ride).

The other busyness data device 120f may comprise any other type and/or configuration of device (or system) that may be utilized to make and/or facilitate decision making processes based at least in part on busyness information. The other busyness data device 120f, for example, may comprise a device (or system) configured to monitor and/or analyze busyness data for event planning, crowd control, etc. Furthermore, any industry that can benefit from the use busyness information may use this information. For example, advertising/marketing and/or promotional agencies/businesses may utilize busyness level in stores to determine the effectiveness of advertisements, crowd control services or government agencies/police may utilize busyness to determine where to place staff and how many resources are needed for a given event, business consulting firms helping businesses determining where to locate the next store, banks/lending institutions may use busyness to determine what businesses to lend money to, and/or businesses may use busyness levels to determine appropriate staffing levels.

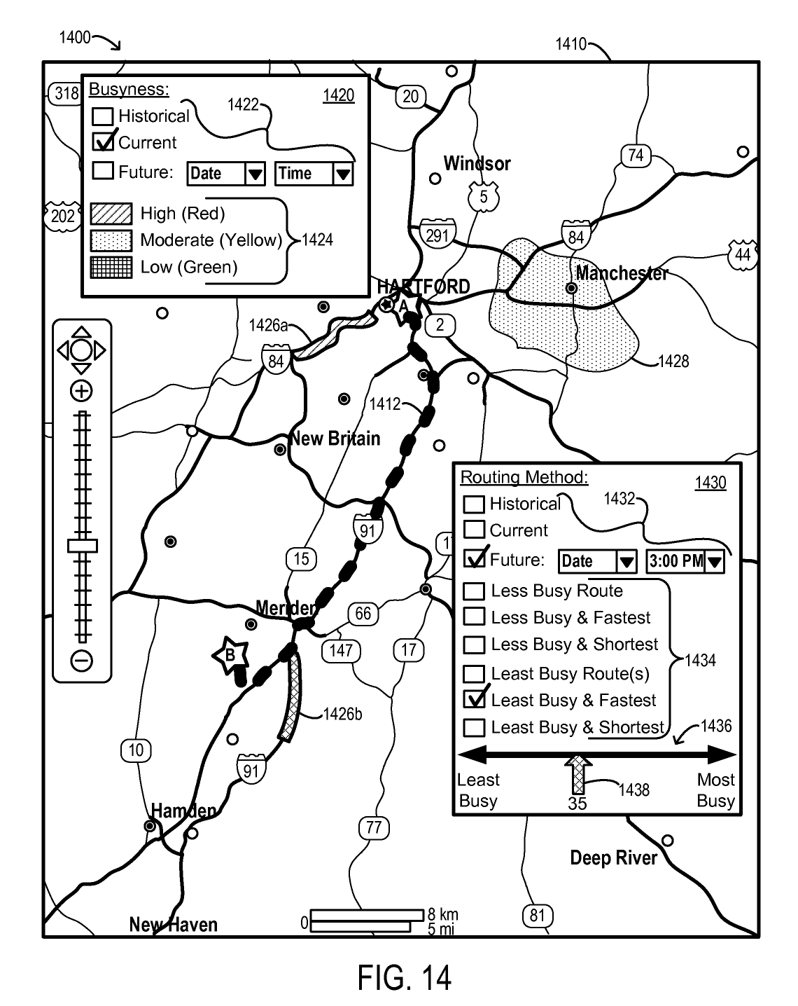

In some embodiments, various user interfaces may be utilized to enhance the ability to comprehend or use busyness data/indices (which may often represent complex busyness metrics, calculations, and/or concepts). An application for a mobile device (such as an Apple® iPhone® application, for example) may, in some embodiments, provide a visual indication of various busyness metrics for stores, entertainment venues (such as amusement parks), restaurants, roads, buses, trains, amusement parts, entertainment venues, etc., that are nearby and/or are otherwise of interest. According to some embodiments, busyness data may be depicted visually on a map and/or as a layer on a map, such as may be provided, for example, by Google® Maps. Such visually-depicted busyness information may comprise real-time, delayed, historical (e.g., historical aggregate, average, trend), and/or predicted data. In such a manner, for example, a customer of busyness data may utilize a mobile and/or other device to view a map of busyness data that allows the customer to more efficiently plan errands, shopping, travel/transportation, and/or other tasks (described in more detail with respect to FIG. 14 herein).

In some embodiments, the level of busyness may be determined by calculating the people density of a given area, e.g., the number of people in a given area divided by the area (or volume) occupied. In particular, if there are three people in a nine square foot (9 sq. ft.) area (e.g., three feet (3 ft.) by three feet (3 ft.)), this may be considered very crowded or busy, and there is a high likelihood that one persons actions will affect at least one other person. However, if only three (3) people occupy a space of ten thousand square feet (10,000 sq. ft.);e.g., one hundred feet (100 ft.) by one hundred feet (100 ft.)), this would likely be considered not crowded or busy. In some embodiments, there may be pre-set dimensions for commonly used areas, such as lanes on highways or aisles in grocery stores, which may have a predetermined standard width for calculating density. However, for other locations or objects, the dimensions may need to be determined or provided by other sources, such as the busyness sensors 306 or from the insured directly, e.g., provided by the potential insured in an on-line application for insurance. Also, the size of the area may need to be “cropped” to be only the area where the people are located not the entire potential use area. For example, if there are three (3) people occupying a ten thousand square foot (10,000 sq. ft.) area, but they are all located within two feet (2 ft.) of each other, e.g., because there is something of interest in that area, then the area for which the density is calculated may be cropped (or reduced) to more accurately calculate the people density. In some embodiments, there may be a people dispersion determination level or mapping which shows the people density variation across an object. For example, a two or three dimensional (2-D or 3-D) electronically displayed map, chart, or graph may be created which shows a view (e.g., a top view, or any other view) of a busyness object and show the people density levels across the object in different colors (e.g., red is high density, blue is low density) or topographical lines (e.g., close lines show high density, further spaced lines show low density) or any other format. Also, there may be a selectable button or check box to show past, present and/or predicted future density (or busyness) levels across the object.

In some embodiments, there may be situations where it is only important to know the number of people and the density is not important, such as a line at a ticket box office. In that case, the busyness information that may be needed is the number of people in line and possibly how fast the line is moving. If the number of people in line is high, a fast moving line may be a lower risk than a slow moving line, as people have more time to interact with each other. Conversely, a fast moving line may be a higher risk than a slow moving line as the people are moving faster and there is a greater chance of people bumping into each other, or tripping over a hazard, otherwise experiencing an injury or loss. According to some embodiments, the number of people and/or objects in a given area (e.g., utilized for calculating busyness density) may be determined utilizing GPS and/or other satellites, triangulation, RFID, and/or other location and/or tracking technologies (e.g., such as may be employed to locate and/or track a person's cellular telephone and/or other computer device).

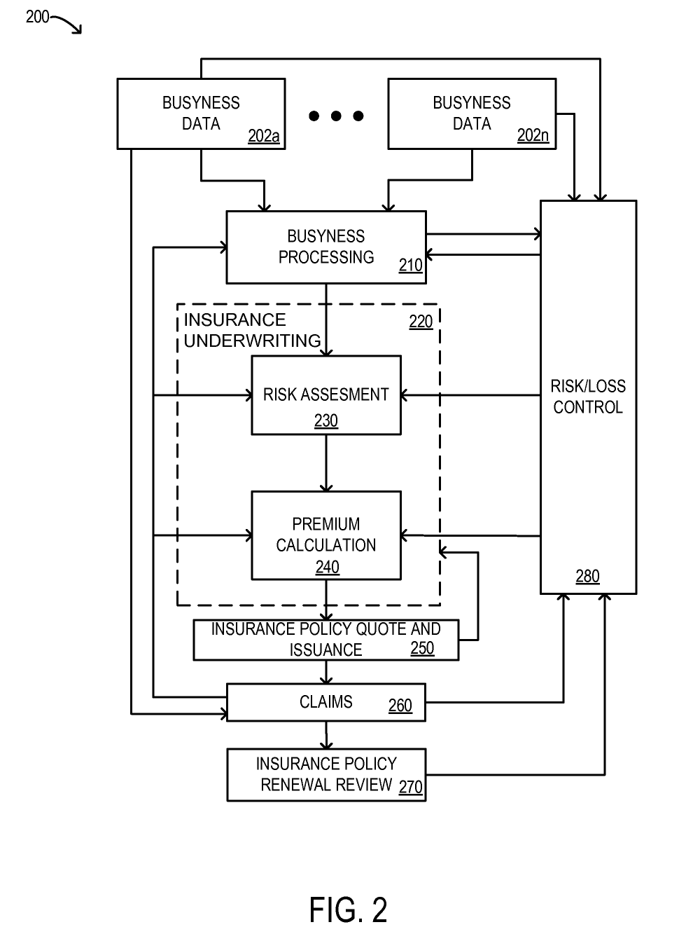

Referring now to FIG. 2, a functional diagram of a process 200 according to some embodiments is shown. In some embodiments, the process 200 may be performed and/or implemented by and/or otherwise associated with one or more specialized and/or specially-programmed computers, computer terminals, computer servers, computer systems and/or networks, and/or any combinations thereof (e.g., by one or more insurance company and/or underwriter computers). The functional diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processor) result in performance according to any one or more of the embodiments described herein.

According to some embodiments, the process 200 may comprise one or more actions associated with busyness data 202a-n. The busyness data 202a-n of one or more objects that may be related to and/or otherwise associated with an insurance product and/or policy, for example, may be determined, calculated, looked-up, and/or derived. In some embodiments, the busyness data may be gathered as raw data directly from one or more busyness sensors discussed herein and/or configured to record data indicative of a level of busyness of the object. One or more cameras in proximity to a particular sidewalk, for example, may transmit and/or otherwise provide busyness data 202a-n indicative of a level of busyness (e.g., images, videos, and/or other representations of pedestrian traffic along the sidewalk). In some embodiments, busyness data 202a-n may be provided by an insured/policy holder and/or by a third party (e.g., cell phone tracking via GPS and/or social media “check-in” functionality; as received from the insured and/or from a third party such as a GPS tracking provider and/or social media server).

As depicted in FIG. 2, busyness data 202a-n from a plurality of sources may be gathered. The plurality of busyness data 202a-n may comprise information indicative of a level of busyness of a single object or may comprise information indicative of a level of busyness of a plurality of objects and/or types of objects. A first busyness data 202a may, for example, be descriptive of a current sales volume at a particular supermarket, while other busyness data 202n may be descriptive of a historical sales volume for all analyzed supermarkets in a particular geographic region. In some embodiments, the first busyness data 202a may be descriptive of a number of times per hour (e.g., a rate) at which a drawbridge opens and closes while other busyness data 202n may be descriptive of a level of road traffic traveling across the drawbridge.

According to some embodiments, the process 200 may also or alternatively comprise one or more actions associated with busyness processing 210. As depicted in FIG. 2, for example, some or all of the busyness data 202a-n may be determined, gathered, and/or otherwise obtained for busyness processing 210. In some embodiments, busyness processing 210 may comprise aggregation, analysis, calculation, filtering, conversion, encoding and/or decoding (including encrypting and/or decrypting), sorting, ranking, and/or any combinations thereof. According to some embodiments, a processing device may execute specialized program instructions to process the busyness data 202a-n to define a busyness metric and/or index. Such a busyness metric may, for example, be descriptive (in a qualitative and/or quantitative manner) of historic, current, and/or predicted busyness levels of an object. In some embodiments, the busyness metric may be time-dependent (e.g., a level of busyness of a computer network may be determined based on any given time of day), time or frequency based (e.g., foot traffic per hour), and/or an average, mean, and/or other statistically normalized value (e.g., an index).

In some embodiments, the time rate of change (or derivative or velocity) of busyness may also be a useful parameter to track. For example, if the busyness changes very rapidly (high rate of change), there may be a higher risk of injury or loss than if the busyness builds over a long period of time. Similarly, a second derivative (or acceleration) of busyness may also be useful to track. For example, if the value of busyness acceleration is non-zero it may be an indication that the risk of injury or loss is extremely high, e.g., in the case where a large group of people or mob forms or disperses very quickly, due to a panic or otherwise. Indications of the formation of large groups, such as “flash mobs,” for example, may be indicated by increased cell phone activity and/or increased web traffic at social media sites, for example. In such cases, a riot may occur, looting may occur, or people may get trampled or otherwise injured and/or property may get damaged. In other examples, a swift increase in web traffic at (and/or direct to or from) a particular web site and/or Top-Level Domain (TLD) may indicate an initiation of a Denial-Of-Service (DOS) attack and/or a sudden increase in processing threads and/or memory buffers allocated may indicate a risk of Central Processing Unit (CPU) overload and/or buffer or stack overflow. Also anticipating busyness based on events where large number of people gather (high level of busyness), such as concerts, sporting events, parades, fairs, weddings, funerals, worker strikes, protest marches, riots, or any other event where an large number of people may gather. By watching internet traffic, email traffic, social networks (such as Facebook™, Twitter™, Foursquare™, MySpace™, and the like), texting/cell traffic, and other areas, such events may be capable of being predicted in advance (similar to seeing a hurricane coming on radar), which allows local municipalities, police, fire departments, hospitals, ambulances/EMTs, health care providers, other first responders, internet/network managers, and insurance companies to deploy resources, adjust traffic flow, or perform other actions to anticipate the need and mitigate the risk or loss. Also, this may allow a traveler to change his/her flights based on anticipated busyness.

Further, there may be more sophisticated, single variable or multivariate, single order or multi-order busyness models and/or equations that analyze the busyness data and correlate it to risks and/or losses, and/or for any other uses. In some embodiments, there may be other inputs, variables or events that may trigger high levels of busyness, such as severe weather events, natural disasters, evacuation warnings/alerts, catastrophic events, earthquakes, tornadoes, hurricanes, blizzards, mudslides, typhoons, sporting events, concerts, wars, terrorist/enemy attacks, or the like. Such correlations may be used, for example, to predict the level of busyness in certain areas and thereby help assess and plan for the risk and/or severity of injury and/or losses associated with one or more events occurring. They may also be utilized for planning crowd control resources, natural or man made resources, utilities, or infrastructure management (e.g., water, electricity, fuel, etc.), or designing escape or evacuation routes, or for any other purpose.

According to some embodiments, there may be a correlation between the busyness level and weather events when determining risk of loss. For example, a given busyness level may correlate to a higher risk when there is ice, snow, or rain likely to occur, than when it is dry.

In some embodiments, the process 200 may also or alternatively comprise one or more actions associated with insurance underwriting 220. Insurance underwriting 220 may generally comprise any type, variety, and/or configuration of underwriting process and/or functionality that is or becomes known or practicable. Insurance underwriting 220 may comprise, for example, simply consulting a pre-existing rule, criteria, and/or threshold to determine if an insurance product may be offered, underwritten and/or issued to customers, based on any relevant busyness data 202a-n. One example of an insurance underwriting 220 process may comprise one or more of risk assessment 230 and/or premium calculation 240 (e.g., as shown in FIG. 2). In some embodiments, while both the risk assessment 230 and the premium calculation 240 are depicted as being part of an exemplary insurance underwriting 220 procedure, either or both of the risk assessment 230 and the premium calculation 240 may alternatively be part of a different process and/or different type of process.

The busyness data 202a-n and/or a result of the busyness processing 210 may, for example, be determined and utilized to conduct risk assessment 230 for any of a variety of purposes. In some embodiments (e.g., as shown), the risk assessment 230 may be conducted as part of a rating process for determining how to structure an insurance product and/or offering. A “rating engine” utilized in an insurance underwriting process may, for example, retrieve a busyness metric (e.g., provided as a result of the busyness processing 210) for input into a calculation (and/or series of calculations and/or a mathematical model) to determine a level of risk likely to be associated with a particular object.

According to some embodiments, the process 200 may also or alternatively comprise one or more actions associated with premium calculation 240 (e.g., which may be part of the insurance underwriting 220). In the case that the process 200 comprises the insurance underwriting 220 process, for example, the risk assessment 230 may be utilized by a “pricing engine” to calculate (and/or look-up or otherwise determine) an appropriate premium to charge for an insurance policy associated with the object for which the busyness data 202a-n was collected and for which the risk assessment 230 was performed. In some embodiments, the object analyzed may comprise an object for which an insurance product is sought (e.g., the analyzed object may comprise an automobile for which an automobile insurance policy is desired or a business for which business insurance is desired). According to some embodiments, the object analyzed may be an object other than the object for which insurance is sought (e.g., the analyzed object may comprise a tunnel through which the automobile for which the automobile insurance policy is desired is often driven or a road near a construction project).

According to some embodiments, the process 200 may also or alternatively comprise one or more actions associated with insurance policy quote and/or issuance 250. Once a policy has been rated, priced or quoted and the customer has accepted the coverage terms, the insurance company may, for example, bind and issue the policy by hard copy and/or electronically to the customer/insured.

In general, a customer may visit a website and/or an insurance agent, for example, provide the needed information about the customer and type of desired insurance, and request an insurance policy and/or product. According to some embodiments, the insurance underwriting 220 is performed using information about the potential insured and the policy is issued based on the result thereof. Insurance coverage may, for example, be evaluated, rated, priced, and/or sold to one or more customers, at least in part based on the busyness data 202a-n. Also, an insurance company may have the potential customer indicate electronically, on-line, or otherwise whether they have any busyness sensing devices (and/or which specific devices they have) and/or whether they are willing to install them or have them installed. In some embodiments, this may be done by check boxes, radio buttons, or other form of data input/selection, on a web page and/or via a mobile device application.

According to some embodiments, the process 200 may also or alternatively comprise one or more actions associated with claims 260. In the insurance context, for example, after an insurance product is provided and/or policy is issued (e.g., via the insurance policy quote and issuance 250), one or more insurance claims may be filed against the product/policy. In some embodiments (as depicted in FIG. 2), such as in the case that a first object associated with the insurance policy is somehow involved with one or more insurance claims 260, first busyness data 202a of the object or related objects may be gathered and/or otherwise obtained. According to some embodiments, such busyness data 202a-n may comprise data indicative of a level of busyness of the object at the time of casualty or loss (e.g., as defined by the one or more claims 260). Information on claims may be provided to the busyness processing 210, risk assessment 230, and/or premium calculation 240 to update, improve, and/or enhance these procedures and/or devices.

In some embodiments, the process 200 may also or alternatively comprise insurance policy renewal review 270. Busyness data 202a-n may be utilized, for example, to determine if and/or how an existing insurance policy (e.g., provided via the insurance policy quote and issuance 250) may be renewed. According to some embodiments, such as in the case that an insured is involved with and/or in charge of (e.g., responsible for) providing the busyness data 202a-n, a review may be conducted to determine if the correct amount, frequency, and/or type or quality of the busyness data 202a-n was indeed provided by the insured during the original term of the policy. In the case that the busyness data 202a-n was lacking, the policy may not, for example, be renewed and/or any discount received by the insured for providing the busyness data 202a-n may be revoked or reduced. In some embodiments, the customer may be offered a discount for having certain busyness sensing devices or being willing to install them or have them installed (or be willing to adhere to certain thresholds based on measurements from such devices).

According to some embodiments, the process 200 may also or alternatively comprise one or more actions associated with risk/loss control 280. Any or all data gathered as part of a claims 260 process, for example, may be gathered, collected, and/or analyzed to determine how (if at all) one or more of a rating engine (e.g., the risk assessment 230), a pricing engine (e.g., the premium calculation 240), the insurance underwriting 220 process, and/or the busyness processing 210 itself, should be updated to reflect actual and/or realized risk, costs, and/or other issues associated with the busyness data 202a-n. Results of the risk/loss control 280 may, according to some embodiments, be fed back into the process 200 to refine the risk assessment 230, the premium calculation 240 (e.g., for subsequent insurance queries and/or calculations), the insurance policy renewal review 270 (e.g., a re-calculation of an existing policy for which the one or more claims 260 were filed), and/or the busyness processing 210 to appropriately scale the output of the risk assessment 280.

B. Busyness Data Sourcing

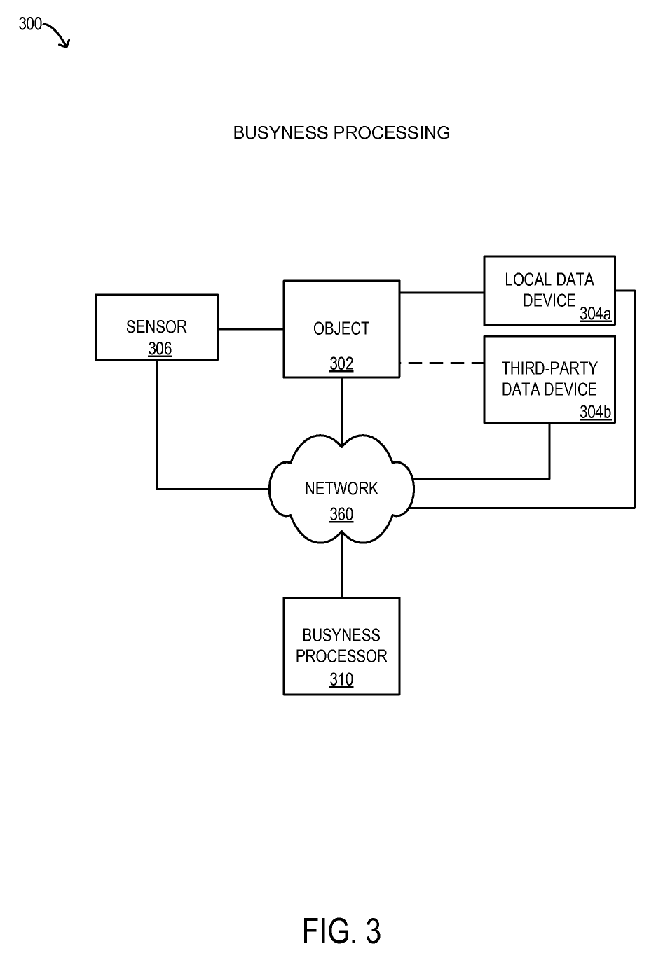

Turning to FIG. 3, a block diagram of a system 300 according to some embodiments is shown. In some embodiments, the system 300 may execute, process, facilitate, and/or otherwise be associated with the process 200 described in conjunction with FIG. 2 herein (and/or a portion thereof, such as the busyness data 202a-n). In some embodiments, the system 300 may comprise an object 302, a local data device 304a, and/or a third-party data device 304b. The object 302 may also or alternatively be monitored by a busyness sensor 306. According to some embodiments, any or all of the object 302, the local data device 304a, the third-party data device 304b, and the busyness sensor 306 may be in communication with one another and/or with a busyness processor 310. In some embodiments, communication between some or all of the components 302, 304a-b, 306, 310 of the system 300 may be conducted via a network 360. In some embodiments, fewer or more components, objects, and/or data than are shown in FIG. 3 may be included in the system 300.

According to some embodiments, the object 302 may comprise an object for which busyness data (such as the busyness data 202a-n of FIG. 2) is desired. The object 302 may, for example, comprise an object identified as being associated with risk that is relevant and/or significant with respect to an insurance policy and/or an investment, loan, or even a wager (e.g., a “risk object”). In particular, a business applying for a loan may appear to be a better or worse risk for a lending institution based on the historical, current, or projected busyness level of the area in which the business is located. For example, if a new highway is planned to be built near a business, the business projection may be high (as compared to previous levels), thereby making it a better risk than may appear currently or historically. Similarly, a business may appear to be a better or worse investment risk based on the historical, current, or projected busyness level of the area the business is located. For example, for short term investments, knowing the projected busyness over an investment period may make an investment a better risk and help determine the best timing for the investment.

In some embodiments, the object 302 may comprise an object for which a level of busyness otherwise is or becomes desirable to know (e.g., a consumer may want to know how busy various local restaurants are before making dinner plans for the evening). In some embodiments, the object 302 may be associated with various stored data such as may be stored on the local data device 304a and/or the third-party data device 304b.

The object 302 may be of such a nature, for example, that data descriptive of the object 302 and/or one or more busyness metrics of the object 302 is stored on the local data device 304a. In the case that the object 302 comprises a highway, for example, data descriptive of traffic levels, accidents, roadwork, vehicle speeds, etc., may be stored by the local data device 304a, which may comprise, for example, a server of a state department of transportation (e.g., the local data device 304a may be owned and/or operated by an owner and/or operator of the object 302). In such an embodiment, the adjective “local” in the local data device 304a means that the data stored therein may be sensed, recorded, captured, and/or stored by an entity with a close relationship to the object 302 (such as an owner, operator, lessee, lessor, tenant, etc.). According to some embodiments, the local data device 304b may also or alternative be in physical proximity to the object 302 (e.g., “local” in terms of geospatial relationships, as opposed to ownership and/or control). In the case that the object 302 comprises a retail store, for example, the store may record video footage (e.g., security cameras), record sales data (e.g., revenues, cash flow, products sold and/or returned or exchanged, sales volumes and/or rates, and/or length of lines and/or service queues), record energy usage, and/or other parameters that may be stored on and/or via the local data device 304b.

In some embodiments, the object 302 may also or alternatively be associated with data stored by a third-party device 304b. A third-party entity (e.g., a party other than an owner and/or operator, etc., of the object 302 and other than an end-user of any busyness data associated therewith) such as a third-party vendor collecting data on behalf of the owner, a marketing firm, government agency and/or regulatory body, and/or demographic data gathering and/or processing firm may, for example, monitor metrics associated with the object 302 (e.g., despite not being closely related to the object 302 by nature of ownership, financial interest, and/or control) for various purposes deemed useful by the third-party, and such metrics may be stored on and/or via the third-party data device 304b.

The third-party data device 304b may, in some embodiments, be in direct communication with the object 302 such as in the case that the third-party data device 304b is situated and/or configured to receive data directly from the object 302. As an example, the third-party data device 304b may comprise a memory device of a Global Positioning System (GPS) receiver and/or transceiver (and/or other tracking device) that is physically coupled to the object 302 (such as a memory device coupled to receive data from a LoJack® SafetyNet™ monitoring bracelet (available from the LoJack® Corporation of Westwood, Mass.) utilized by the Project Lifesaver International (PLI) initiative). See, for example, http://www.projectlifesaver.org. According to some embodiments, the third-party data device 304b may not be in direct and/or even any communication with the object 302. In the case that the third-party data device 304b stores sales and/or demographic data offered for sale by a third-party demographic and/or marketing firm such as The Nielson Company of New York, N.Y. (See, http://en-us.nielsen.com), for example, the data stored therein may be gathered from sources other than the object 302 such as government records and/or public filings, testimonials, surveys, etc.

According to some embodiments, as discussed hereinabove, data descriptive of the object may also or alternatively be provided by the busyness sensor 306. The busyness sensor 306 may, for example, comprise one or more of a digital or analog camera/video device (e.g., a Closed-Circuit TV (CCTV) camera, a webcam, satellite imaging device, aerial imaging device, robotic imaging device, and/or a Pan-Tilt-Zoom (PTZ)-enabled camera), a motion sensor, door sensors (e.g., that detect the opening and/or closing of a door, or detect a revolving door speed and/or people throughput), a light sensor, an optical sensor, a laser sensor, a tactile sensor, a RADAR, LADAR, or SONAR sensor, a weight and/or mass sensor, a switch (e.g., a pressure switch, rocker switch, and/or mercury switch), a thermal sensor, a static sensor, an electrical current sensor, an electro and/or magnetic field sensor, a distance sensor, an acoustic sensor, a temperature sensor, any other type of sensor, and/or any combinations thereof. In some embodiments, an entity other than an owner, operator, and/or other entity with ownership and/or control of the object 302 and/or other than the third-party entity associated with the third-party data device 304b may own or operate the busyness sensor 306. In some embodiments, the busyness sensor(s) 306 may comprise tracking devices that are attached to people, e.g., cell phones or PDAs (and/or location determining hardware and/or software thereof or associated therewith), or the like, RFID tags, or other location tracking devices located on or within people or objects, or on or within clothing or items (e.g., jewelry, watches, etc.) attached to people or objects, and capable of monitoring, storing and/or transmitting their location, speed, and/or acceleration.

In one embodiment, for example, the object may comprise a business location (e.g., that stores some data pertinent to running the business on the local data device 304a), the third-party data device 304b may be owned and/or operated by a demographic research entity that collects data on local, regional, nationwide, and/or international businesses, and the busyness sensor 306 may be owned and/or operated by or on behalf of or for the benefit of an insurance carrier and/or provider that is an insurer of the business and/or business location or of individuals working at and/or otherwise interacting with the business. In such a manner, for example, the insurance company may monitor information that is not already monitored and/or available via either or both of the local data device 304a and the third-party data device 304b, and/or may utilize the busyness sensor 306 to verify the accuracy of local and/or third-party data (and/or the reporting thereof—e.g., to detect insurance fraud).

In some embodiments, any or all of the local data, third-party data, and/or sensor data (e.g., gathered and/or stored by the local data device 304a, the third-party data device 304b, and the busyness sensor 306, respectively) may be provided to the busyness processor 310. Such data may be “pushed” to the busyness processor 310 (e.g., automatically sent and/or transmitted to the busyness processor 310 upon occurrence of certain triggering events such as the data being gathered, sensed, obtained, stored, and/or a pre-determined “push” time interval elapsing) and/or may be “pulled” by the busyness processor 310 (e.g., the busyness processor 310 may proactively seek, look-up, query, and/or request the data from the various sources 304a-b, 306). According to some embodiments, the busyness processor 310 may comprise any type and/or configuration of processor that is operable to process data associated with the object 302 and that is operable to determine, there from, one or more busyness metrics, parameters, and/or indices (e.g., via implementation of logic and/or mathematical calculations). The busyness processor 310 may, in some embodiments, comprise one or more human operators that process the data and/or may comprise one or more “computerized processors”.

As utilized herein, the term “computerized processor” generally refers to any type or configuration of primarily non-organic processing device that is or becomes known. Such devices may include, but are not limited to, computers, Integrated Circuit (IC) devices, CPU devices, logic boards and/or chips, Printed Circuit Board (PCB) devices, electrical or optical circuits, switches, electronics, optics and/or electrical traces. A sub-class of computerized processors, as utilized herein, may comprise “mechanical processors” which may generally include, but are not limited to, mechanical gates, mechanical switches, cogs, wheels, gears, flywheels, cams, mechanical timing devices, etc.

According to some embodiments, the busyness processor 310 may be or include any type, quantity, and/or configuration of processor (human and/or computerized) that is or becomes known. The busyness processor 310 may comprise, for example, an Intel® XEON™ processor or an Intel® Core i7™ Processor available from Intel® Corporation of Santa Clara, Calif. In some embodiments, the busyness processor 310 may comprise multiple inter-connected processors, microprocessors, and/or micro-engines. According to some embodiments, the busyness processor 310 may comprise one or more computers operated by an entity that aggregates, processes, analyzes, distributes, and/or sells busyness data. The busyness processor 310 may comprise a computer server and/or system of an entity that aggregates and computes busyness data for sale to various customers and/or subscribers, for example, and/or may comprise a computer server and/or system of an insurance company (and/or investment, holdings, management, and/or other company) that may utilize busyness data to structure sales of products (e.g., insurance products and/or investment products) to one or more customers.

C. Busyness Data Processing

In some embodiments, the busyness processor 310 may receive raw data descriptive of the object, attributes of the object, and/or actions, activities, or events associated with the object via the network 360 and may process such data to determine, calculate, and/or otherwise define one or more busyness metrics, parameters, and/or indices. The number of packets transmitted and/or received by a communications network or device may be analyzed, for example, to develop a qualitative and/or quantitative score, rank, and/or index that may be utilized to easily compare the busyness of the network and/or device to other similar networks or devices. In some embodiments, the score, rank, and/or index may also or alternatively be normalized so that it can be compared to a wider variety of types of objects. A busyness score of one hundred (100) for a computer network may be statistically normalized, for example, such that an arterial roadway with the same score of one hundred (100) may be considered to have the same level of busyness as the network. In some embodiments, busyness data gathered by the busyness processor 310 may be analyzed to determine a plurality of qualitative value bands descriptive of the busyness of the object 302 (e.g., a busyness index).

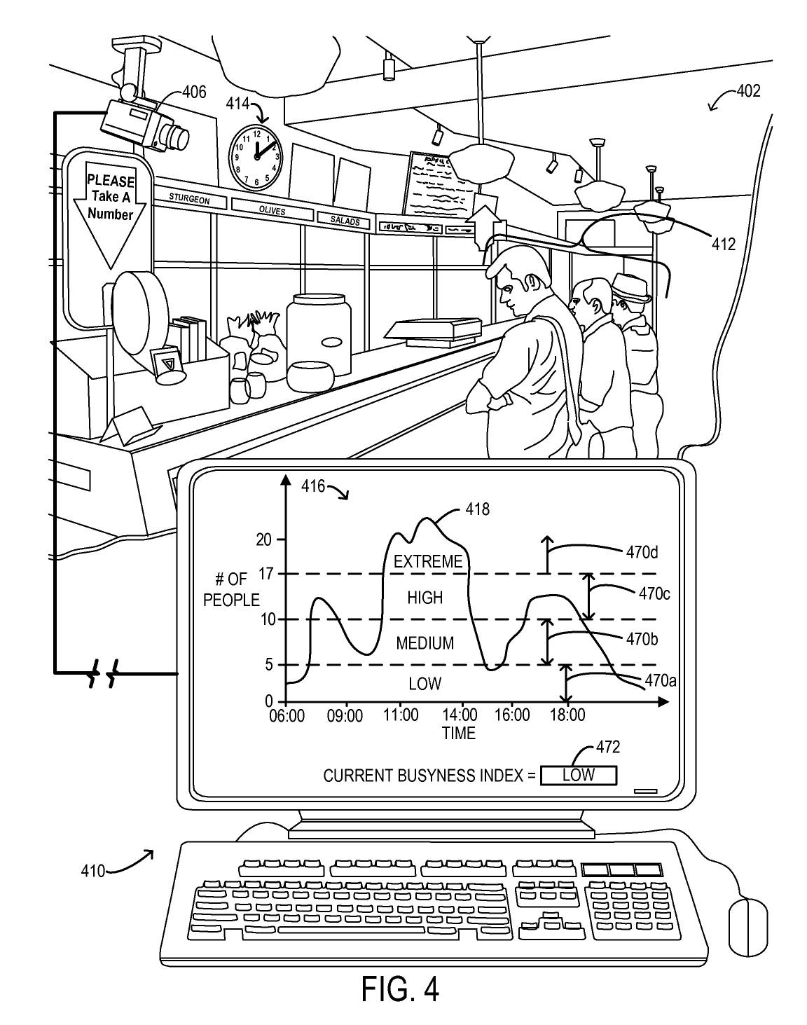

Referring to FIG. 4, for example, a perspective diagram of an exemplary system 400 according to some embodiments is shown. In some embodiments, the system 400 may comprise an object 402 such as the deli counter of a supermarket as depicted, a sensor 406 such as the camera depicted, and/or a busyness processor 410 such as the PC depicted. According to some embodiments, any or all of the components 402, 406, 410 of the system 400 may be similar in configuration and/or functionality to the similarly named and/or numbered components described with respect to the systems 100, 300 of FIG. 1 and/or FIG. 3 herein. Fewer or more components and/or various configurations of the components 402, 406, 410 may be included in the system 400 without deviating from the scope of embodiments described herein.

The exemplary system 400 of FIG. 4 illustrates one example of how busyness data may be analyzed to produce a busyness index descriptive of the busyness of a retail store. The camera 406 (e.g., the busyness sensor 306 of FIG. 3) in a supermarket may record images of a deli counter 402 (e.g., the object 302 of FIG. 3), for example, and may provide the images to the busyness processor 410 for analysis. The busyness processor 410 may, for example, analyze the images to determine a number of people 412 waiting for service at the deli counter 402 (e.g., utilizing human analysis and/or image analysis software) throughout the business day of the supermarket (e.g., over time 414). As depicted in FIG. 4, the number of people 412 waiting in line may be plotted on the y-axis of a graph 416 versus time 414 on the x-axis. As a result of the plotting, a data and/or trend line 418 may be defined. As depicted, the trend line 418 shows that the deli counter is busiest during lunch, with a significant spike in busyness during breakfast and/or as people travel to work, with another significant spike in busyness around dinner time and/or around the end of the typical work day.

In some embodiments, the trend line 418 and/or the underlying busyness data may be analyzed to determine a plurality of ranges or bands 470a-d defining a qualitative metric that is indicative of the busyness of the deli counter 402. As depicted, the data plotted on the graph 416 and described by the trend line 418 may, for example, be broken into four (4) busyness index bands 470a, 470b, 470c, 470d. The first busyness index band 470a may be labeled “LOW” and may be indicative of a baseline or threshold level of busyness of the deli counter 402 (e.g., in the case that the number of people 412 is in the range zero (0) to four (4)). The second busyness band 470b may be labeled “MEDIUM” and may be indicative of an average and/or typical level of busyness of the deli counter 402 (e.g., in the case that the number of people 412 is in the range five (5) to nine (9)). The third busyness band 470c may be labeled “HIGH” and may be indicative of the typical high-volume level of busyness experienced at the deli counter 402 during peak and/or rush periods (e.g., in the case that the number of people 412 is in the range ten (10) to sixteen (16)). The fourth busyness band 470d may be labeled “EXTREME” and may be indicative of the highest levels of busyness that have historically occurred and/or are likely to occur at the deli counter 402 (e.g., in the case that the number of people 412 is greater than seventeen (17)).

As shown in FIG. 4, a current busyness index 472 of the deli counter 402 may be determined, such as by comparing the current number of people 412 at the deli counter 402 to the busyness index bands 470a-d. In the example, the current number of people 412 of three (3) falls within the range of the first busyness band 470a, or “LOW” busyness. According to some embodiments, the current busyness index 472 may be utilized by an end-user to determine whether the current time is a good time to visit the deli counter 402. In the case that an end-user is provided access to such data 472 via, for example, a portable electronic device (such as a cellular telephone, PDA, and/or an in-store customer device such as a Scan It!™ personal barcode scanner made by Motorola®, Inc. of Schaumburg, Ill., and available for use at stores owned by Giant™ Food, LLC, or other similar device), the end-user may quickly and easily manage if and when the end-user visits the deli counter 402 based on the real-time busyness data and/or current busyness index 472. According to some embodiments, the current busyness index 472 and/or typical, average, mean, and/or historic trends in busyness may be utilized as a metric in assessing risk and/or calculating premiums (e.g., for insurance policies—such as insurance policies for the supermarket, for deli counter 402 personnel, and/or for individuals visiting the deli counter 402).

While qualitative labels such as “LOW”, “MEDIUM”, “HIGH”, and “EXTREME” are utilized for exemplary purposes with respect to FIG. 4, other qualitative as well as quantitative descriptors may also or alternatively be utilized. For example, numeric descriptors such as “1”, “2”, “3”, “4”, alphabetic descriptors such as “A”, “B”, “C”, “D”, alpha-numeric descriptors such as “A1”, “A2”, “A3”, “B4”, or any other type of descriptor that is or becomes known or practicable may be utilized to express busyness. There may also be multiple tiers of busyness levels. For example, a numerical tiering, e.g., 1 to 10, and a second level tiering, e.g., low, medium, high, based on ranges in each of the numerical tiers. In some embodiments, the busyness level may be normalized across different objects such that a busyness level of “HIGH” and a busyness level of ninety (90) may have identical or similar meanings with respect to busyness of different objects. For example, at a large, well-staffed retailer, it may be deemed to be below a “low” level of busyness until thirty (30) customers are present. Also, different insurance companies may put different weight factors or filters on the busyness index value depending upon their own empirical experiences with certain objects, object types, and/or sub-objects or sub-object types. For example, a “high” busyness level of a deli counter may not be deemed as important or as indicative of higher levels of risk as a “high” busyness level of a ticket box office.

D. Busyness Data Aggregation

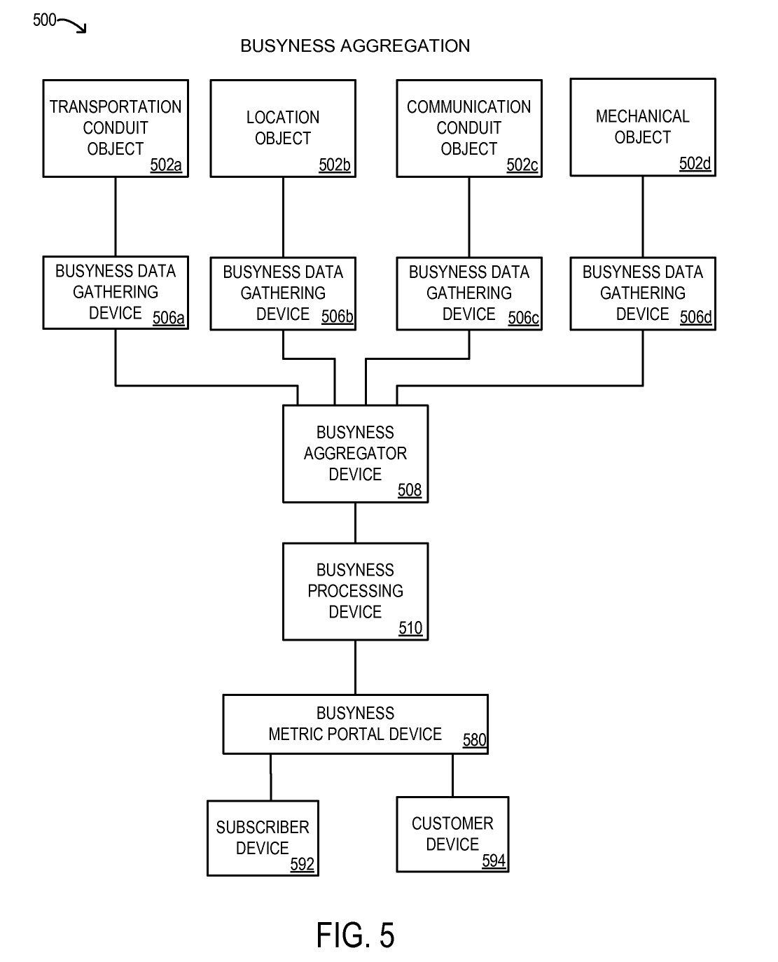

Turning now to FIG. 5, a block diagram of a system 500 according to some embodiments is shown. In some embodiments, the system 500 may comprise one or more objects 502a-d, one or more busyness gathering devices 506a-d, a busyness aggregator device 508, a busyness processing device 510, a busyness metric portal device 580, a subscriber device 592, and/or a customer device 594. According to some embodiments, any or all of the components 502a-d, 506a-d, 508, 510, 580, 592, 594 of the system 500 may be similar in configuration and/or functionality to the similarly named and/or numbered components described with respect to the systems 100, 300, 400 of FIG. 1, FIG. 3, and/or FIG. 4 herein. Fewer or more components and/or various configurations of the components 502a-d, 506a-d, 508, 510, 580, 592, 594 may be included in the system 500 without deviating from the scope of embodiments described herein. While multiples of some components 502a-d, 506a-d are depicted and while single instances of other components 508, 510, 580, 592, 594 are depicted, for example, any component 502a-d, 506a-d, 508, 510, 580, 592, 594 depicted in the system 500 may comprise a single device, a combination of devices and/or components 502a-d, 506a-d, 508, 510, 580, 592, 594, and/or a plurality of devices, as is or becomes desirable and/or practicable.

According to some embodiments, the system 500 may be configured to gather, aggregate, and/or process busyness information for a plurality of objects 502a-d. While any type of desired object 502 may be monitored and/or analyzed to determine busyness and/or indicators thereof, as depicted in FIG. 5, such objects 502 may generally fall into one or more categories and/or classes. Such categories may include, for example, a transportation conduit category containing a transportation conduit object 502a, a location category containing a location object 502b, a communication conduit category containing a communication conduit object 502c, and/or a mechanical category containing a mechanical object 502d, as described hereinbefore.

As described herein, a transportation conduit object 502a may generally comprise one or more transportation pathways such as sidewalks, paths, streets, highways, canals, seaways and/or shipping lanes, railroads, aisles in supermarkets, etc. A location object 502b may generally comprise one or more physical locations such as buildings, street corners, intersections, railroad crossings, stores, shops, malls, entertainment facilities (e.g., sports tracks, casinos, and/or theatres), bridges, tunnels, etc. A communication conduit object 502c may generally comprise one or more communication pathways such as radio frequencies, wireless and/or wired networks, computer systems, electrical wires (e.g., electrical and/or optical transmission lines that “communicate” electricity and/or optically), websites, chat rooms, social media sites and/or games, etc. A mechanical object 502d may generally comprise one or more vehicles such as cars, trucks, vans, buses, bicycles, motorcycles, mopeds, scooters, trolleys, trains, trams, subway cars, ships, boats, jet-skis/wave runners, and/or one or more elevators, escalators, drawbridge mechanisms, railroad crossing signals, railroad track switches, electrical transformers, electrical inverters, electrical generation equipment and/or machines, cranes, conveyer belts, factory equipment, etc.

In some embodiments, the busyness data gathering devices 506a-d may be in communication with and/or otherwise coupled to receive data descriptive of the objects 502a-d. The busyness data gathering devices 506a-n may be utilized, for example, to sense (e.g., in the case of a sensor such as the busyness sensor 306 of FIG. 3 and/or the camera 406 of FIG. 4), monitor, retrieve (e.g., such as by scanning and/or copying), store, sort, rank, and/or otherwise organize and/or process data descriptive of the objects 502a-d. The data gathered may generally comprise data that is indicative of some measure of busyness of one or more of the objects 502a-d (and/or that is descriptive of one or more of the objects 502a-d but is indicative of the busyness of another object 502a-d). In some embodiments, one or more of the busyness data gathering devices 506a-n may conduct pre-processing of the gathered data. Analog data may converted to digital form, for example, data may be grouped, sorted, and/or cleansed (e.g., duplicate data and/or outliers may be removed), compressed, and/or encoded or encrypted data (such as from a “secure” sensor and/or data storage system) may be decoded or decrypted. Similarly, raw data gathered from one or more of the objects 502a-d may be encoded and/or encrypted by a busyness data gathering device (e.g., prior to transmitting and/or otherwise providing the information to the busyness aggregator 508).

According to some embodiments, the busyness aggregator device 508 may gather, retrieve, sort, rank, store, and/or otherwise organize and/or obtain busyness data from one or more of the busyness data gathering devices 506a-n. In some embodiments, the busyness aggregator device 508 may comprise a “bot” and/or may store a program that seeks and retrieves busyness data from various sources (such as from the busyness data gathering devices 506a-n). In one simple exemplary case where each of the busyness data gathering devices 506a-n comprises a webcam, for example, the busyness aggregator device 508 may comprise a camera hub, Digital Video Recorder (DVR), and/or PC configured to receive data from each of the webcams. In some embodiments, the busyness aggregator device 508 may also or alternatively perform other function such as data load management, power distribution (e.g., providing electrical power to the plurality of busyness data gathering devices 506a-n, such as by functioning as Power Sourcing Equipment (PSE) in accordance with the Power over Ethernet (PoE) transmission standard 802.3at® published by the IEEE, Sep. 1, 2009). In some embodiments, the busyness aggregator device 508 may provide aggregated busyness data to the busyness processing device 510.

The busyness processing device 510 may, for example, comprise one or more CPU devices and/or other logic components (e.g., a computerized processor) coupled to receive aggregated busyness data from the busyness aggregator device 508. As described herein, the busyness processing device 510 may perform various processing functions on the aggregated busyness data. The results of such processing may, according to some embodiments, comprise definition of one or more busyness metrics such as busyness ranks, scores, and/or indices. In some embodiments, the busyness processing device 510 may also or alternatively store the aggregated busyness data. The busyness processing device 510 may comprise, for example, a plurality of data storage devices (not separately depicted in FIG. 5) that store raw, pre-processed, aggregated, summarized, and/or historical busyness data descriptive of the busyness of the objects 502a-d. The busyness processing device 510 may also or alternatively store one or more qualitative and/or quantitative busyness scores, ranks, and/or indices associated with the objects 502a-d. In some embodiments, the busyness processing device 510 may also perform other functionality such as facilitating risk assessment and/or premium determinations (e.g., the busyness processing device 510 may comprise one or more computers operating a specialized program and/or instructions that utilize busyness data to assess risk and calculate premiums for insurance policies—e.g., the insurance underwriting 220 of FIG. 2).

Busyness data and/or a busyness level or index may also or alternatively be determined for multiple areas and/or parts of a given object. For example, in a supermarket, the busyness of the deli counter, the various aisles, and/or the check-out counters, may each have their own respective busyness level or rating. In such a case, the overall busyness rating/level for the supermarket at any given time may be a combination of each of the sub-busyness levels of the object (e.g., some mathematical expression combining each of the busyness levels of the deli counter, one or more aisles, and/or one or more check-out counters of the supermarket). In some embodiments, there may be multiple and/or sub-busyness levels or indices that are calculated and provided for different areas and/or parts of a given object, e.g., Deli-High, Checkout-Low, Aisles-Med. These sub-levels may be utilized, for example, to predict how busyness moves from one area/part of an object to another. For example, if the aisles of a supermarket have a “high” busyness level but the check-out counters have a “low” busyness level (e.g., at any particular point and/or range in time), it may be possible to predict when and/or to what extent the busyness level of the check-out counter may increase. Similarly, if the entry-way busyness is “high”, the aisles will likely experience “high” busyness soon. Such processing and/or predictive modeling may be performed, for example, by the aggregator device 508 and/or the busyness processing device 510.

In some embodiments, the system 500 may include the busyness metric portal device 580 that may, for example, be communicatively coupled to receive busyness data and/or metrics from the busyness processing device 510 and/or communicatively coupled to provide such data and/or metrics to one or more of the subscriber device 592 and the customer device 594. According to some embodiments, the busyness portal device 580 may comprise a server and/or web server configured to function as a “front end” and/or to provide a Graphical User Interface (GUI) via which subscribers and/or customers may access and/or purchase busyness data and/or metrics. The busyness portal device 580 may comprise, for example, an e-commerce “store front” such as may be implemented utilizing StoreFront.net™ provided by StoreFront® sCommerce of Olathe (Kansas City metropolitan area), KS, and/or may be sold and/or provided as an application for a cellular telephone or PDA, such as an Apple® iPhone® application. In such a manner, corporate customers and/or subscribers may access and/or be provided with busyness data for business purposes such as for structuring insurance policy terms and/or premiums and/or public or general customers may access busyness data for informative and/or decision-making purposes (such as what roads to avoid on the way home from work, which restaurants or stores are currently or expected to soon be crowded, etc.).

The subscriber device 592 and/or the customer device 594 may, according to some embodiments, be or include any type or configuration of network device and/or computing device that is or becomes known or practicable. The subscriber device 592 and/or the customer device 594 may, for example, comprise a telephone (e.g., wired or wireless) and/or other communication device associated with a customer of or subscriber to busyness metrics and/or data as described herein. In some embodiments, either or both of the subscriber device 592 and the customer device 594 may comprise a portable device and/or mobile terminal such as a PDA, a cellular telephone, a GPS navigation device, a laptop computer, or the like. The subscriber device 592 may generally be owned and/or operated by an entity that owns and/or has access to a subscription to busyness data and/or metrics provided by the busyness metric portal device 580. The customer device 594 may, in some embodiments, comprise a subscriber device 592 or may comprise, for example, a company workstation communicatively coupled to the busyness metric portal device 580, that may comprise a corporate server and/or corporate-owned and licensed software program and/or package configured to gather, process, and/or provide (e.g., display) busyness data.

Although the busyness data gathering devices 506a-d, the busyness aggregator device 508, and the busyness processing device 510 are depicted as separate devices in FIG. 5, in some embodiments, any or all of the components 502a-d, 506a-d, 508, 510, 580, 592, 594 of the system 500 (such as the busyness data gathering devices 506a-d, the busyness aggregator device 508, and the busyness processing device 510) may be embodied in a single device, apparatus, and/or interconnected system. A single entity (such as an insurance company) may own and/or operate devices configured and/or coupled to function as any or all of the components 502a-d, 506a-d, 508, 510, 580, 582, 584 of the system 500, for example, or a single computer and/or computer server or system may perform any or all of such functions. Similarly, while a one-to-one (1:1) relationship between the objects 502a-d and the busyness data gathering devices 506a-d is depicted in FIG. 5, in some embodiments, any busyness data gathering device 506a-d may be configured and/or coupled to gather data from a plurality of objects 502a-d and/or from a plurality of different types or categories of objects 502a-d. According to some embodiments, different busyness data gathering devices 506a-d may gather data from the same object 502a-d (e.g., there may be overlap in data gathering functionality). In some embodiments, busyness data gathering devices 506a-d may also or alternatively collect, gather, store, and/or provide other types of data such as environmental conditions (e.g., weather).

E. Busyness-Based Risk Assessment

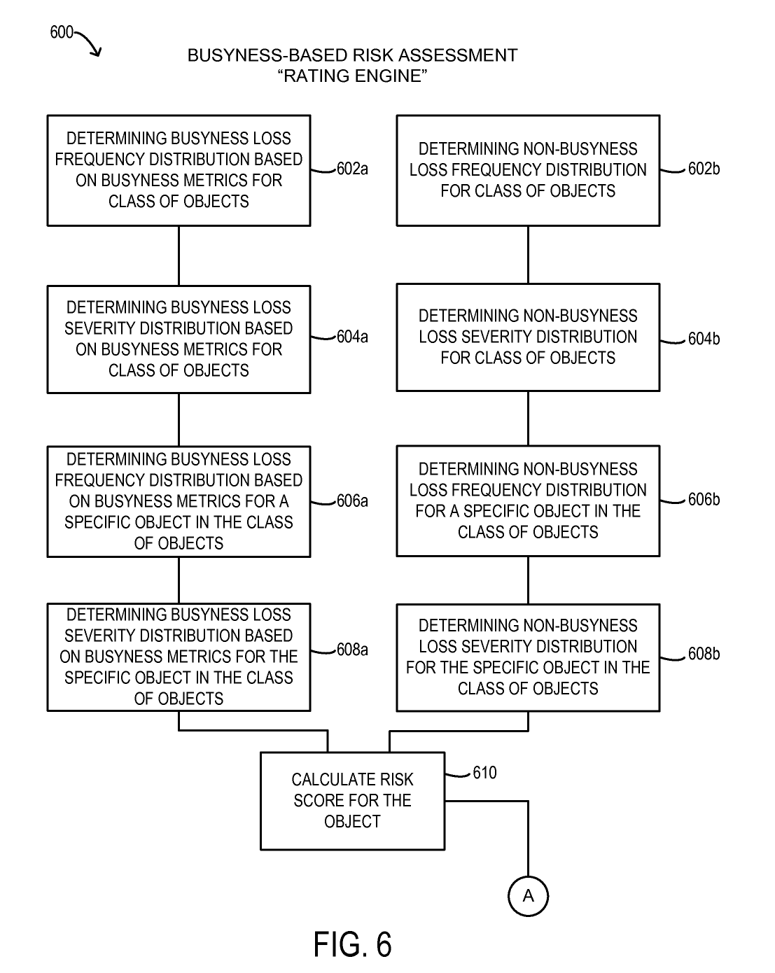

Turning now to FIG. 6, a flow diagram of a method 600 according to some embodiments is shown. In some embodiments, the method 600 may comprise a busyness risk assessment method which may, for example, be described as a “rating engine”. According to some embodiments, the method 600 may be implemented, facilitated, and/or performed by or otherwise associated with any of the systems 100, 300, 400, 500 of FIG. 1, FIG. 3, FIG. 4, and/or FIG. 5 herein. In some embodiments, the method 600 may be associated with the process 200 of FIG. 2. The method 600 may, for example, comprise a portion of the process 200 such as the risk assessment 230.

According to some embodiments, the method 600 may comprise determining one or more loss frequency distributions for a class of objects, at 602a-b. In some embodiments, a first loss frequency distribution may be determined, at 602a, based on busyness data and/or metrics. Busyness data (such as the busyness data 202a-n of FIG. 2) for a class of objects such as communication conduit objects (e.g., the communication conduit object 502c of FIG. 5) and/or for a particular type of object (such as a Wi-Fi® router) within a class of objects (such as electronic devices) may, for example, be analyzed to determine relationships between various busyness data and/or metrics and empirical data descriptive of actual insurance losses for such object types and/or classes of objects. A busyness processing and/or analytics system (e.g., a busyness processor 110, 310, 410, 510 as described with respect to any of FIG. 1, FIG. 3, FIG. 4, and/or FIG. 5 herein) may, according to some embodiments, conduct regression and/or other mathematical analysis on various busyness metrics to determine and/or identify mathematical relationships that may exist between such metrics and actual sustained losses and/or casualties.

Similarly, at 602b, a second loss frequency distribution may be determined based on non-busyness data. According to some embodiments, the determining at 602b may comprise a standard or typical loss frequency distribution utilized by an entity (such as an insurance company) to assess risk. The non-busyness metrics utilized as inputs in the determining at 602b may include, for example, age of a building or car, driving record of an individual, a criminal record of an individual, color of a vehicle, etc. In some embodiments, the loss frequency distribution determinations at 602a-b may be combined and/or determined as part of a single comprehensive loss frequency distribution determination. In such a manner, for example, expected total loss probabilities (e.g., taking into account both busyness and non-busyness data) for a particular object type and/or class may be determined. In some embodiments, this may establish and/or define a baseline, datum, average, and/or standard with which individual risk assessments may be measured.

According to some embodiments, the method 600 may comprise determining one or more loss severity distributions for a class of objects, at 604a-b. In some embodiments, a first loss severity distribution may be determined, at 604a, based on busyness data and/or metrics. Busyness data (such as the busyness data 202a-n of FIG. 2) for a class of objects such as location objects (e.g., the location object 502b of FIG. 5) and/or for a particular type of object (such as a video rental store) may, for example, be analyzed to determine relationships between various busyness data and/or metrics and empirical data descriptive of actual insurance losses for such object types and/or classes of objects. A busyness processing and/or analytics system (e.g., a busyness processor 110, 310, 410, 510 as described with respect to any of FIG. 1, FIG. 3, FIG. 4, and/or FIG. 5 herein) may, according to some embodiments, conduct regression analysis on various busyness metrics to determine and/or identify mathematical relationships that may exist between such metrics and actual sustained losses and/or casualties.

Similarly, at 604b, a second loss severity distribution may be determined based on non-busyness data. According to some embodiments, the determining at 604b may comprise a standard or typical loss severity distribution utilized by an entity (such as an insurance agency) to assess risk. The non-busyness metrics utilized as inputs in the determining at 604b may include, for example, cost of replacement or repair, ability to self-mitigate loss (e.g., if a building has a fire suppression system and/or automatically closing fire doors), etc. In some embodiments, the loss severity distribution determinations at 604a-b may be combined and/or determined as part of a single comprehensive loss severity distribution determination. In such a manner, for example, expected total loss severities (e.g., taking into account both busyness and non-busyness data) for a particular object type and/or class may be determined. In some embodiments, this may also or alternatively establish and/or define a baseline, datum, average, and/or standard with which individual risk assessments may be measured.

In some embodiments, the method 600 may comprise determining one or more expected loss frequency distributions for a specific object in the class of objects, at 606a-b. Regression and/or other mathematical analysis performed on the busyness loss frequency distribution derived from empirical data, at 602a for example, may identify various busyness metrics and may mathematically relate such metrics to expected loss occurrences (e.g., based on historical trends). Based on these relationships, a busyness loss frequency distribution may be developed at 606a for the specific object. In such a manner, for example, known busyness metrics for a specific object may be utilized to develop an expected distribution (e.g., probability) of occurrence of busyness-related loss for the specific object.

Similarly, regression and/or other mathematical analysis performed on the non-busyness loss frequency distribution derived from empirical data, at 602b for example, may identify various non-busyness metrics and may mathematically relate such metrics to expected loss occurrences (e.g., based on historical trends). Based on these relationships, a non-busyness loss frequency distribution may be developed at 606b for the specific object. In such a manner, for example, known non-busyness metrics for a specific object may be utilized to develop an expected distribution (e.g., probability) of occurrence of non-busyness-related loss for the specific object. In some embodiments, the non-busyness loss frequency distribution determined at 606b may be similar to a standard or typical loss frequency distribution utilized by an insurer to assess risk.

In some embodiments, the method 600 may comprise determining one or more expected loss severity distributions for a specific object in the class of objects, at 608a-b. Regression and/or other mathematical analysis performed on the busyness loss severity distribution derived from empirical data, at 604a for example, may identify various busyness metrics and may mathematically relate such metrics to expected loss severities (e.g., based on historical trends). Based on these relationships, a busyness loss severity distribution may be developed at 608a for the specific object. In such a manner, for example, known busyness metrics for a specific object may be utilized to develop an expected severity for occurrences of busyness-related loss for the specific object.

Similarly, regression and/or other mathematical analysis performed on the non-busyness loss severity distribution derived from empirical data, at 604b for example, may identify various non-busyness metrics and may mathematically relate such metrics to expected loss severities (e.g., based on historical trends). Based on these relationships, a non-busyness loss severity distribution may be developed at 608b for the specific object. In such a manner, for example, known non-busyness metrics for a specific object may be utilized to develop an expected severity of occurrences of non-busyness-related loss for the specific object. In some embodiments, the non-busyness loss severity distribution determined at 608b may be similar to a standard or typical loss frequency distribution utilized by an insurer to assess risk.

It should also be understood that the busyness-based determinations 602a, 604a, 606a, 608a and non-busyness-based determinations 602b, 604b, 606b, 608b are separately depicted in FIG. 6 for ease of illustration of one embodiment descriptive of how busyness metrics may be included to enhance standard risk assessment procedures. According to some embodiments, the busyness-based determinations 602a, 604a, 606a, 608a and non-busyness-based determinations 602b, 604b, 606b, 608b may indeed be performed separately and/or distinctly in either time or space (e.g., they may be determined by different software and/or hardware modules or components and/or may be performed serially with respect to time). In some embodiments, the busyness-based determinations 602a, 604a, 606a, 608a and non-busyness-based determinations 602b, 604b, 606b, 608b may be incorporated into a single risk assessment process or “engine” that may, for example, comprise a risk assessment software program, package, and/or module.

In some embodiments, the method 600 may also comprise calculating a risk score for the object, at 610. According to some embodiments, formulas, charts, and/or tables may be developed that associate various busyness and/or non-busyness metric magnitudes with risk scores. Lower levels of traffic on a road that may be described by a road traffic busyness metric, for example, may equate to a risk score of two (2), while high levels of truck traffic on the road that may be described by a truck traffic busyness metric may equate to a risk score of ten (10). Similarly, lower levels of market capitalization of a company described by a non-busyness metric may equate to a risk score of one (1). Risk scores for a plurality of busyness and/or non-busyness metrics may be determined, calculated, tabulated, and/or summed to arrive at a total risk score for the object and/or for an object class. According to some embodiments, risk scores may be derived from the busyness and/or non-busyness loss frequency distributions and the busyness and/or non-busyness loss severity distribution determined at 606a-b and 608a-b, respectively. More details on one similar method for assessing risk are provided in Applicants' U.S. Pat. No. 7,330,820 entitled “PREMIUM EVALUATION SYSTEMS AND METHODS” which issued on Feb. 12, 2008, the risk assessment concepts and descriptions of which are hereby incorporated by reference herein.

In some embodiments, the results of the method 600 may be utilized to determine a premium for an insurance policy for the specific object analyzed. Any or all of the busyness and/or non-busyness loss frequency distributions of 606a-b, the busyness and/or non-busyness loss severity distributions of 608a-b, and the risk score of 610 may, for example, be passed to and/or otherwise utilized by a premium calculation process via the node labeled “A” in FIG. 6.

F. Busyness-Based Premium Determination

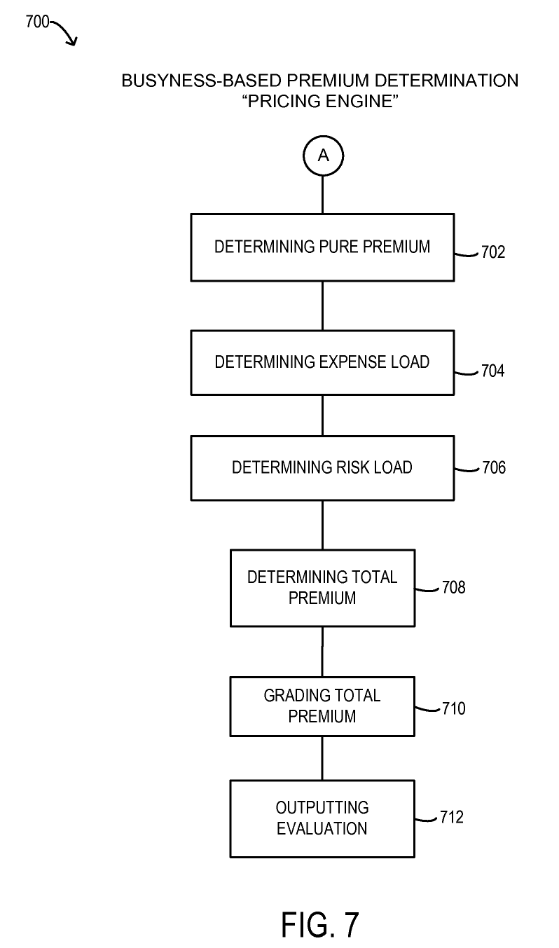

Referring to FIG. 7, for example, a flow diagram of a method 700 (that may initiate at the node labeled “A”) according to some embodiments is shown. In some embodiments, the method 700 may comprise a busyness-based premium determination method which may, for example, be described as a “pricing engine”. According to some embodiments, the method 700 may be implemented, facilitated, and/or performed by or otherwise associated with any of the systems 100, 300, 400, 500 of FIG. 1, FIG. 3, FIG. 4, and/or FIG. 5 herein. In some embodiments, the method 700 may be associated with the process 200 of FIG. 2. The method 700 may, for example, comprise a portion of the process 200 such as the premium calculation 240. Any other technique for calculating an insurance premium that uses busyness information described herein may be used if desired.

In some embodiments, the method 700 may comprise determining a pure premium, at 702. A pure premium is a basic, unadjusted premium that is generally calculated based on loss frequency and severity distributions. According to some embodiments, the busyness and/or non-busyness loss frequency distributions (e.g., from 606a-b in FIG. 6) and the busyness and/or non-busyness loss severity distributions (e.g., from 608a-b in FIG. 6) may be utilized to calculate a pure premium that would be expected, mathematically, to result in no net gain or loss for the insurer when considering only the actual cost of the loss or losses under consideration and their associated loss adjustment expenses. Determination of the pure premium may generally comprise simulation testing and analysis that predicts (e.g., based on the supplied frequency and severity distributions) expected total losses (busyness-based and/or non-busyness-based) over time.

According to some embodiments, the method 700 may comprise determining an expense load, at 704. The pure premium determined at 702 does not take into account operational realities experienced by an insurer. The pure premium does not account, for example, for operational expenses such as overhead, staffing, taxes, fees, etc. Thus, in some embodiments, an expense load (or factor) is determined and utilized to take such costs into account when determining an appropriate premium to charge for an insurance product. According to some embodiments, the method 700 may comprise determining a risk load, at 706. The risk load is a factor designed to ensure that the insurer maintains a surplus amount large enough to produce an expected return for an insurance product.

According to some embodiments, the method 700 may comprise determining a total premium, at 708. The total premium may generally be determined and/or calculated by summing or totaling one or more of the pure premium, the expense load, and the risk load. In such a manner, for example, the pure premium is adjusted to compensate for real-world operating considerations that affect an insurer.

According to some embodiments, the method 700 may comprise grading the total premium, at 710. The total premium determined at 708, for example, may be ranked and/or scored by comparing the total premium to one or more benchmarks. In some embodiments, the comparison and/or grading may yield a qualitative measure of the total premium. The total premium may be graded, for example, on a scale of “A”, “B”, “C”, “D”, and “F”, in order of descending rank. The rating scheme may be simpler or more complex (e.g., similar to the qualitative bond and/or corporate credit rating schemes determined by various credit ratings agencies such as Standard & Poors' (S&P) Financial service LLC, Moody's Investment Service, and/or Fitch Ratings from Fitch, Inc., all of New York, N.Y.) of as is or becomes desirable and/or practicable. More details on one similar method for calculating and/or grading a premium are provided in Applicants' U.S. Pat. No. 7,330,820 entitled “PREMIUM EVALUATION SYSTEMS AND METHODS” which issued on Feb. 12, 2008, the premium calculation and grading concepts and descriptions of which are hereby incorporated by reference herein.

According to some embodiments, the method 700 may comprise outputting an evaluation, at 712. In the case that the results of the determination of the total premium at 708 are not directly and/or automatically utilized for implementation in association with an insurance product, for example, the grading of the premium at 710 and/or other data such as the risk score determined at 610 of FIG. 6 may be utilized to output a indication of the desirability and/or expected profitability of implementing the calculated premium. The outputting of the evaluation may be implemented in any form or manner that is or becomes known or practicable. One or more recommendations, graphical representations, visual aids, comparisons, and/or suggestions may be output, for example, to a device (e.g., a server and/or computer workstation) operated by an insurance underwriter and/or sales agent. One example of an evaluation comprises a creation and output of a risk matrix which may, for example, by developed utilizing Enterprise Risk Register® software which facilitates compliance with ISO 17799/ISO 27000 requirements for risk mitigation and which is available from Northwest Controlling Corporation Ltd. (NOWECO) of London, UK.

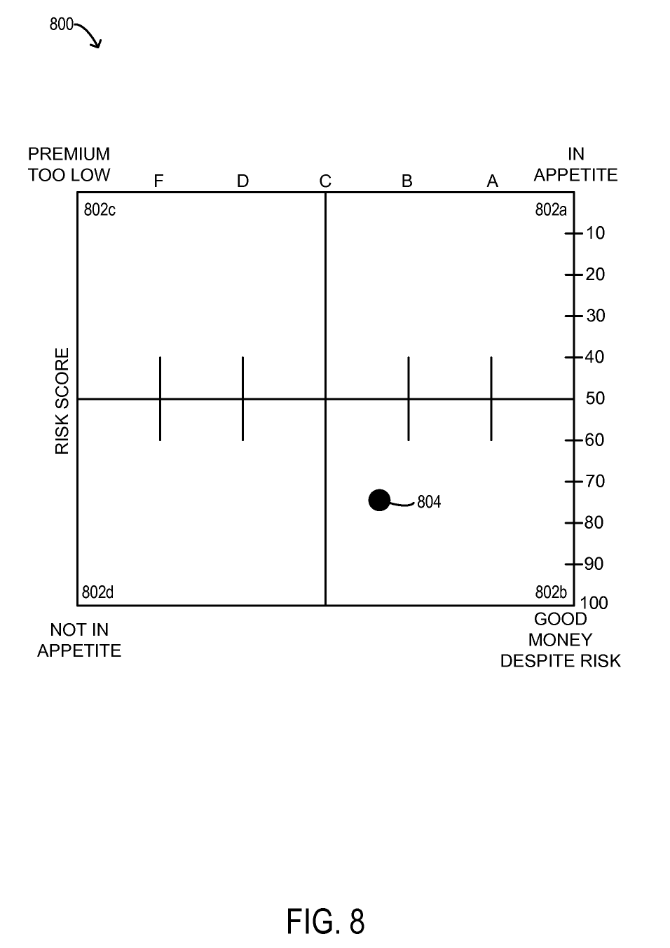

Turning to FIG. 8, for example, a diagram of an exemplary risk matrix 800 according to some embodiments is shown. In some embodiments (as depicted), the risk matrix 800 may comprise a simple two-dimensional graph having an x-axis and a y-axis. Any other type of risk matrix, or no risk matrix, may be used if desired. The detail, complexity, and/or dimensionality of the risk matrix 800 may vary as desired and/or may be tied to a particular insurance product or offering. In some embodiments, the risk matrix 800 may be utilized to visually illustrate a relationship between the risk score (e.g., from 230 of FIG. 2 and/or from 610 of FIG. 6) of an object and the total determined premium (e.g., from 240 of FIG. 2 and/or 708 of FIG. 7; and/or a grading thereof, such as from 710 of FIG. 7) for an insurance product offered in relation to the object. As shown in FIG. 8, for example, the premium grade may be plotted along the x-axis of the risk matrix 800 and/or the risk score may be plotted along the y-axis of the risk matrix 800.

In such a manner, the risk matrix 800 may comprise four (4) quadrants 802a-d (e.g., similar to a “four-square” evaluation sheet utilized by automobile dealers to evaluate the propriety of various possible pricing “deals” for new automobiles). The first quadrant 802a represents the most desirable situations where risk scores are low and premiums are highly graded. The second quadrant 802b represents less desirable situations where, while premiums are highly graded, risk scores are higher. Generally, object-specific data that results in data points being plotted in either of the first two quadrants 802a-b is indicative of an object for which an insurance product may be offered on terms likely to be favorable to the insurer. The third quadrant 802c represents less desirable characteristics of having poorly graded premiums with low risk scores and the fourth quadrant 802d represents the least desirable characteristics of having poorly graded premiums as well as high risk scores. Generally, object-specific data that results in data points being plotted in either of the third and fourth quadrants 802c-d is indicative of an object for which an insurance product offering is not likely to be favorable to the insurer

One example of how the risk matrix 800 may be output and/or implemented with respect to busyness of an object will now be described. Assume, for example, that an automobile policy is desired by a consumer and/or that an automobile insurance policy product is otherwise analyzed to determine whether such a policy would be beneficial for an insurer to issue. Typical risk metrics such as the driving record of the consumer, age of the vehicle, safety features of the vehicle, and/or crash test ratings of the vehicle (consumer safety crash tests and/or damage and/or cost-based crash tests) may be utilized to produce expected loss frequency and loss severity distributions (such as determined at 606b and 608b of FIG. 6).

In some embodiments, busyness metrics of the vehicle (i.e., the object being insured) such as how many people typically ride in the vehicle and/or how many hours are logged on the engine of the vehicle may also be utilized to produce expected busyness loss frequency and busyness loss severity distributions (such as determined at 606a and 608a of FIG. 6). In some embodiments, busyness metrics of objects other than vehicle (i.e., other than the object being insured) such as traffic levels of roads typically traveled on by the vehicle and/or how often a traffic control device at an intersection through which the vehicle may travel and/or typically travels may also or alternatively be utilized to produce expected busyness loss frequency and busyness loss severity distributions (such as determined at 606a and 608a of FIG. 6). According to some embodiments, singular loss frequency and loss severity distributions may be determined utilizing both typical risk metrics as well as busyness metrics (of the object being insured and/or of other associated objects).

In the case that the automobile is typically driven through a busy intersection and/or the traffic control device managing traffic flow through the intersection is operated at a high frequency (e.g., a signal device is switched on and off and/or cycles quite often), especially when compared to typical intersections and/or traffic control signals, the risk score for the vehicle may be determined to be relatively high, such as seventy-five (75) on a scale from zero (0) to one hundred (100). Of course other non-busyness factors such as the driving record of the consumer and/or primary driver of the vehicle (and/or other factors) may also contribute to the risk score for the vehicle, consumer, and/or insurance product associated therewith. Also, if the typical times of day and/or days of the week are known for when the car drives through a specific intersection, this can be correlated with historical and/or predicted busyness levels of the intersection at those times of day to provided more accurate risk scores. As a result, the sample rate of the traffic monitoring device may affect the accuracy of the risk score. Also, web-cams, the busyness sensor 306, and/or any other devices may monitor human traffic (e.g., walkers/pedestrians, bikers, skateboarders, and/or rollerbladers), which may be factored into the busyness level for the area.

The total premium calculated for a potential insurance policy offering covering the vehicle (e.g., determined at 708 of FIG. 7) may, to continue the example, be graded between “B” and “C” (e.g., at 710 of FIG. 7) or between “Fair” and “Average”. The resulting combination of risk score and premium rating may be plotted on the risk matrix 800, as represented by a data point 804 shown in FIG. 8. The data point 804, based on the busyness-influenced risk score and the accordingly busyness-influenced premium calculation, is plotted in the second quadrant 802b, in a position indicating that while the risk of insuring the vehicle is relatively high, the calculated premium is probably large enough to compensate for the level of risk. In some embodiments, an insurer may accordingly look favorably upon issuing such as insurance policy to the consumer to cover the vehicle in question and/or may consummate a sale of such a policy to the consumer (e.g. based on the evaluation output at 712 of FIG. 7, such as decision and/or sale may be made).

G. Busyness-Based Risk/Loss Control

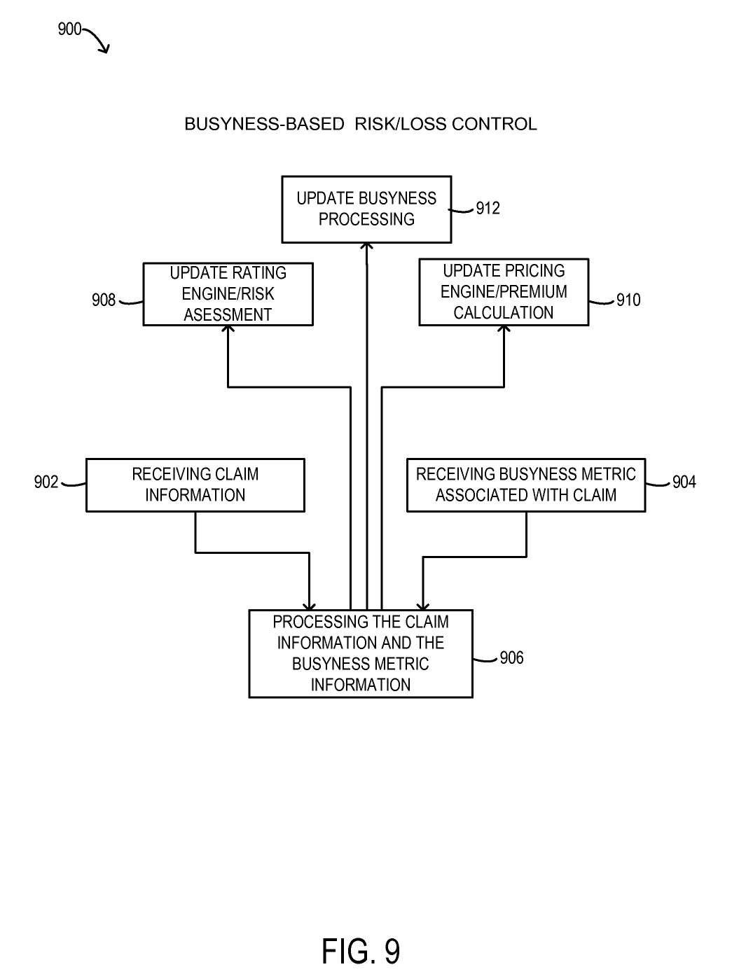

Turning now to FIG. 9, a flow diagram of a method 900 according to some embodiments is shown. In some embodiments, the method 900 may comprise a busyness risk loss control method. According to some embodiments, the method 900 may be implemented, facilitated, and/or performed by or otherwise associated with any of the systems 300, 400, 500 of FIG. 3, FIG. 4, and/or FIG. 5 herein. In some embodiments, the method 900 may be associated with the process 200 of FIG. 2. The method 900 may, for example, comprise a portion of the process 200 such as the risk/loss control 280. In some embodiments, the method 900 may also or alternatively be associated with any of the methods 500, 600, 700 described in relation to FIG. 5, FIG. 6, and/or FIG. 7 herein. The method 900 may comprise, in some embodiments for example, a continuation of the busyness-based risk assessment method 600 of FIG. 6 and/or the busyness-based premium determination method 700 of FIG. 7.

According to some embodiments, the method 900 may comprise receiving claim information, at 902. A claim may be received from an insured/policy holder with respect to a loss or casualty (e.g., an accident or any other loss event) sustained with respect to an object covered by an insurance policy for which an insurance company receives premiums, for example. In some embodiments, the claim may be made with respect to an insurance product for which an evaluation was output (e.g., during a sales and/or underwriting process) such as at 712 of FIG. 7. The claim information may generally comprise and/or indicate data descriptive of the loss such as severity and/or cause, or other information.

In some embodiments, the method 900 may comprise receiving a busyness metric associated with the claim, at 904. Information descriptive of a busyness metric and/or raw busyness data associated with the severity and/or cause of the loss, for example, may be provided by the consumer as part of a claims process (e.g., may be received in conjunction with the information received at 902). According to some embodiments, the busyness data and/or metric may be received from sources other than the consumer. Returning to the example of the insured automobile described with respect to FIG. 8, for example, the driver of the vehicle may not have access to and/or may not be capable of properly rating the level of traffic on a road where (and when) an accident occurred. Thus, in some embodiments, the insurer and/or a third-party may utilize the claim information to locate, identify, and/or retrieve busyness data for the road where the accident occurred and at and/or around the time of the accident or loss. According to some embodiments, the consumer may provide such information, the vehicle may be configured to provide desired claim and/or busyness information, a third-party data provider, and/or the insurance company may get it directly from the sensing devices.

Utilizing a GPS device and/or other data gathering and/or recording device, for example, the vehicle may be capable of determining where a loss occurred, when it occurred, and may also be able to provide information regarding local traffic conditions at the time (e.g., either obtained from a traffic monitoring device (such as web-cams, the busyness sensor 206, or the like) and/or a traffic monitoring service or a Department of Motor Vehicles (DMV) or Department of Transportation (DOT), for example, or self-derived, such as by utilizing an on-board camera to monitor the traffic density of roads traveled and/or an accelerometer capable of discerning likely traffic congestion levels based on braking and/or movement patterns). In such embodiments, the vehicle may automatically report and/or provide such information to the insurer (which may, for example, execute the method 900).

In some embodiments, the method 900 may comprise processing the claim information and the busyness metric information, at 906. The loss information and/or the busyness metric information may be combined with previous and/or historic loss data and/or busyness metric information, for example, to define a new set of data that may be utilized to access risk and/or determine premiums for new insurance policies and/or products, and/or may be utilized to update risk and/or pricing for one or more existing policies (such as the policy of the driver of the vehicle involved in the example accident), or it may be utilized to update how the busyness metric is determined based on the specific busyness data/sensors.

The method 900 may, for example, update a rating engine at 908 and/or update a pricing engine at 910. According to some embodiments, the new loss information and/or the new loss-related busyness information may be fed back into one or more of the rating engine and the pricing engine utilized by an insurer to evaluate and/or structure insurance products and pricing thereof. The busyness-based risk assessment method of 600 of FIG. 6 and/or the busyness-based premium determination method 700 of FIG. 7 may, for example, be conducted and/or re-conducted, based on the newly available claim and/or claim-related busyness information. In such a manner, insurance policy risk analysis and/or pricing may be updated to reflect the most recent data available, increasing the probability that the risk and pricing models will maintain appropriate levels of accuracy. If the busyness metric of a certain area changes dramatically, the insurance company may notify the customer directly (e.g., by cell phone, PDA, pager, e-mail, text message, and/or a phone call) to alert the insured of the change in risk of the area that may be of interest to the insured. More details on various types of sensing technologies and methods for communicating to an insured are described in Applicants' U.S. patent application Ser. No. 12/426,039 entitled “METHODS AND SYSTEMS FOR AUTOMATED PROPERTY INSURANCE INSPECTION” which was filed on Apr. 17, 2009 and which published as U.S. Patent Application Publication No. US2009/0265193 on Oct. 22, 2009, such concepts and descriptions of which are hereby incorporated by reference herein. Such communication to the insured may be provided as part of “risk control” services provided by the insurance company or by a third party having access to busyness information. Accordingly, the insurance company or the third party may collect, analyze and distribute busyness information and send alerts regarding busyness and suggestions to mitigate risks associated with increased busyness. For example, a commercial business that has a high level of busyness at certain times of the year or certain days of the year, or when certain types of events or weather occur, may receive a busyness alert in advance of the busy day or period and suggest the floors get cleaned or additional staffing is provided or other suggestions to help mitigate a risk of loss due to the upcoming busyness. In addition, a company or person may select to have certain services dispatched automatically, such as cleaning service, staffing service, or the like, when a certain level of busyness is predicted.

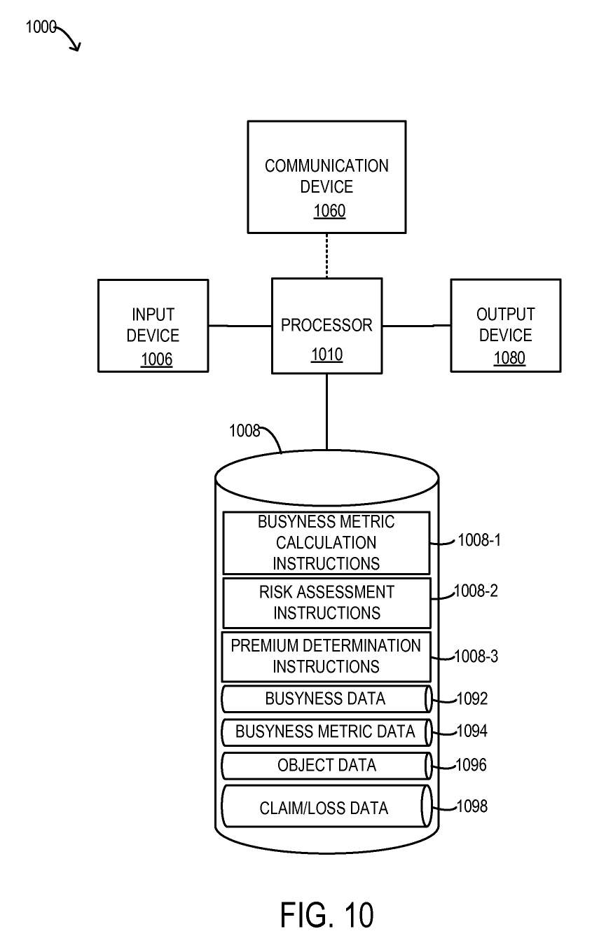

Turning to FIG. 10, a block diagram of an apparatus 1000 according to some embodiments is shown. In some embodiments, the apparatus 1000 may be similar in configuration and/or functionality to any of the busyness processors 310, 410 of FIG. 3 and/or FIG. 4, the busyness processing device 510, the busyness data gathering devices 506a-d, the busyness aggregator device 508, the busyness metric portal device 580, the subscriber device 582, and/or the customer device 584, all of FIG. 5 herein. The apparatus 1000 may, for example, execute, process, facilitate, and/or otherwise be associated with any of the process 200 of FIG. 2 and/or any of the methods 600, 700, 900 described in conjunction with FIG. 6, FIG. 7, and FIG. 9 herein. In some embodiments, the apparatus 1000 may comprise an input device 1006, a memory device 1008, a processor 1010, a communication device 1060, and/or an output device 1080. According to some embodiments, any or all of the components 1006, 1008, 1010, 1060, 1080 of the apparatus 1000 may be similar in configuration and/or functionality to any similarly named and/or numbered components described with respect to the systems 300, 400, 500 of FIG. 3, FIG. 4, and/or FIG. 5 herein. Fewer or more components and/or various configurations of the components 1006, 1008, 1010, 1060, 1080 may be included in the apparatus 1000 without deviating from the scope of embodiments described herein.

According to some embodiments, the processor 1010 may be or include any type, quantity, and/or configuration of processor that is or becomes known. The processor 1010 may comprise, for example, an Intel® IXP 2800 network processor or an Intel® XEON™ Processor coupled with an Intel® E7501 chipset. In some embodiments, the processor 1010 may comprise multiple inter-connected processors, microprocessors, and/or micro-engines. According to some embodiments, the processor 1010 (and/or the apparatus 1000 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1000 comprises a server such as a blade server, necessary power may be supplied via a standard AC outlet, power strip, surge protector, and/or Uninterruptible Power Supply (UPS) device.

In some embodiments, the input device 1006 and/or the output device 1080 are communicatively coupled to the processor 1010 (e.g., via wired and/or wireless connections and/or pathways) and they may generally comprise any types or configurations of input and output components and/or devices that are or become known, respectively. The input device 1006 may comprise, for example, a keyboard that allows an operator of the apparatus 1000 to interface with the apparatus 1000 (e.g., by a consumer, such as to purchase insurance policies priced utilizing busyness metrics and/or to monitor busyness data of local destinations, and/or by an underwriter and/or insurance agent, such as to evaluate risk and/or calculate premiums for an insurance policy). In some embodiments, the input device 1006 may comprise a sensor configured to provide information such as encoded busyness information to the apparatus 1000 and/or the processor 1010. The output device 1080 may, according to some embodiments, comprise a display screen and/or other practicable output component and/or device. The output device 1080 may, for example, provide insurance and/or investment pricing and/or risk analysis to a potential customer (e.g., via a website) and/or to an underwriter or sales agent attempting to structure an insurance (and/or investment) product (e.g., via a computer workstation). According to some embodiments, the input device 1006 and/or the output device 1080 may comprise and/or be embodied in a single device such as a touch-screen monitor.

In some embodiments, the communication device 1060 may comprise any type or configuration of communication device that is or becomes known or practicable. The communication device 1060 may, for example, comprise a network interface card (NIC), a telephonic device, a cellular network device, a router, a hub, a modem, and/or a communications port or cable. In some embodiments, the communication device 1060 may be coupled to provide data to a customer device, such as in the case that the apparatus 1000 is utilized as a busyness data portal. The communication device 1060 may, for example, comprise a cellular telephone network transmission device that sends signals indicative of busyness metrics to customer and/or subscriber handheld, mobile, and/or telephone devices. According to some embodiments, the communication device 1060 may also or alternatively be coupled to the processor 1010. In some embodiments, the communication device 1060 may comprise an IR, RF, Bluetooth™, and/or Wi-Fi® network device coupled to facilitate communications between the processor 1010 and another device (such as a customer device and/or a third-party device).

The memory device 1008 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 1008 may, according to some embodiments, store one or more of busyness metric calculation instructions 1008-1, risk assessment instructions 1008-2, premium determination instructions 1008-3, busyness data 1092, busyness metric data 1094, object data 1096, and/or claim/loss data 1098. In some embodiments, the busyness metric calculation instructions 1008-1, risk assessment instructions 1008-2, and/or premium determination instructions 1008-3 may be utilized by the processor 1010 to provide output information via the output device 1080 and/or the communication device 1060 (e.g., the risk matrix 800 of FIG. 8).

According to some embodiments, the busyness metric calculation instructions 1008-1 may be operable to cause the processor 1010 to process busyness data 1092 as described herein. Busyness data 1092 received via the input device 1006 and/or the communication device 1060 may, for example, be analyzed, sorted, filtered, decoded, decompressed, ranked, scored, plotted, and/or otherwise processed by the processor 1010 in accordance with the busyness metric calculation instructions 1008-1. In some embodiments, raw busyness data 1092 descriptive of how busy an object is may be fed by the processor 1010 through one or more mathematical and/or statistical formulas and/or models in accordance with the busyness metric calculation instructions 1008-1 to define one or more busyness metrics (e.g., described by the busyness metric data 1094) that may then be utilized for various purposes as described herein.

According to some embodiments, the risk assessment instructions 1008-2 may be operable to cause the processor 1010 to perform a risk assessment as described herein. Busyness metric data 1094 (and/or busyness data 1092) of an object may be analyzed to create loss distributions, for example, that may be utilized to generate a risk score for an object being insured (e.g., in accordance with the method 600 of FIG. 6). The risk assessment instructions 1008-2 may, in some embodiments, utilize the object data 1096 to determine relationships between objects for which insurance is sought and related objects that are not the subject of an insurance product under evaluation (e.g., the object data 1096 may, in addition to storing information on objects such as vehicles that are insured, store information relating such vehicles to roads, intersections, and/or other externality objects that may be related to the vehicles).

In some embodiments, the premium determination instructions 1008-3 may be executed by the processor 1010 to calculate an insurance premium for an insurance product (e.g., based on the busyness metric data 1094 and/or the busyness data 1092). According to some embodiments, the risk assessment instructions 1008-2 and/or the premium determination instructions 1008-3 may utilize the loss data 1098 (such as by implementing the busyness risk/loss control method 900 of FIG. 9) to update and/or revise risk and/or premium determinations, respectively. The apparatus 1000 may function as a computer terminal and/or server of an insurance and/or underwriting company, for example, that is utilized to process insurance applications. In some embodiments, the apparatus 1000 may comprise a web server and/or other portal (e.g., an IVRU) that provides busyness data 1092 and/or busyness metric data 1094 to consumers and/or corporations.

Any or all of the exemplary instructions and data types described herein and other practicable types of data may be stored in any number, type, and/or configuration of memory devices that is or becomes known. The memory device 1008 may, for example, comprise one or more data tables or files, databases, table spaces, registers, and/or other storage structures. In some embodiments, multiple databases and/or storage structures (and/or multiple memory devices 1008) may be utilized to store information associated with the apparatus 1000. According to some embodiments, the memory device 1008 may be incorporated into and/or otherwise coupled to the apparatus 1000 (e.g., as shown) or may simply be accessible to the apparatus 1000 (e.g., externally located and/or situated).

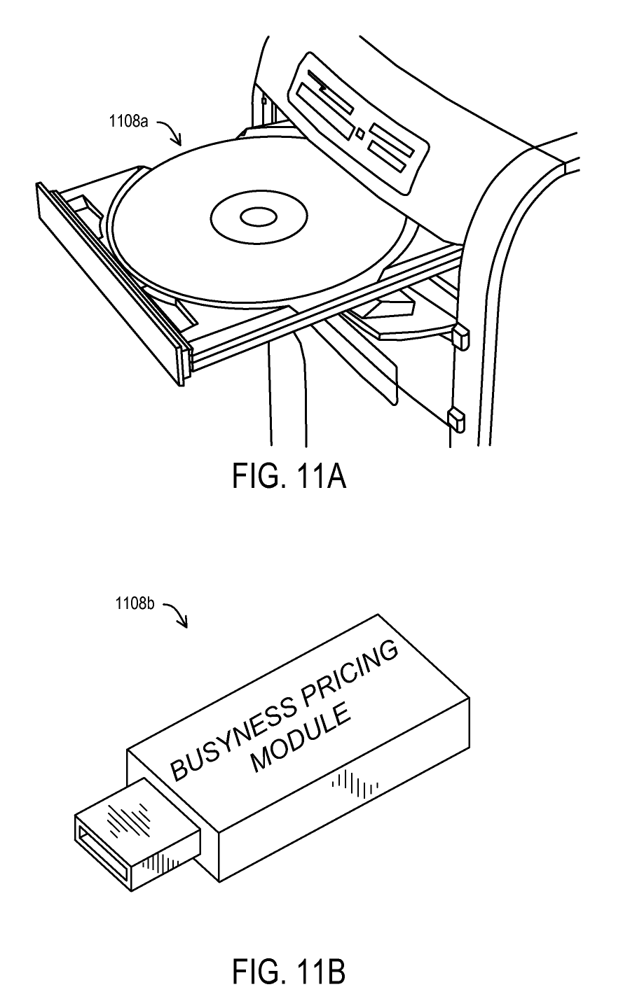

Referring to FIG. 11A and FIG. 11B, perspective diagrams of exemplary data storage devices 1108a-b according to some embodiments are shown. The data storage devices 1108-a-b may, for example, be utilized to store instructions and/or data such as the busyness metric calculation instructions 1008-1, the risk assessment instructions 1008-2, and/or the premium determination instructions 1008-3, each of which is described in reference to FIG. 9 herein. In some embodiments, instructions stored on the data storage devices 1108a-b may, when executed by a processor, cause the implementation of and/or facilitate any of the various processes 200 and/or methods 500, 600, 700, 900 described herein. The data storage devices 1108-a-b may also or alternatively store data such as the busyness data 202a-n, 1092, busyness metric data 1094, object data 1096, and/or claim/loss data 1098 as described herein.

According to some embodiments, the first data storage device 1108a may comprise a CD, CD-ROM, DVD, Blu-Ray™ Disc, and/or other type of optically-encoded disk and/or other storage medium that is or becomes know or practicable. In some embodiments, the second data storage device 1108b may comprise a USB keyfob, dongle, and/or other type of flash memory data storage device that is or becomes know or practicable. The data storage devices 1108-a-b may generally store program instructions, code, and/or modules that, when executed by a processing device cause a particular machine to function in accordance with embodiments described herein. The data storage devices 1108-a-b depicted in FIG. 11A and FIG. 11B are representative of a class and/or subset of computer-readable media that are defined herein as “computer-readable memory” (e.g., memory devices as opposed to transmission devices).

H. Interfaces

In some embodiments, data indicative of busyness and/or busyness metrics and/or indices may be output and/or provided in various advantageous forms. Data may be provided utilizing graphs, charts, tables, maps, and/or other visual and/or tabular forms of output as is or becomes desirable or practicable. According to some embodiments, such output may be provided via mobile devices (e.g., operated by customers, field agents, employees, contractors and/or others) such as smart phones, PDA devices, tablet computers (e.g., the Apple® iPad™), etc., and/or via one or more other GUI interfaces such as via a website, computer/video screen and/or kiosk.

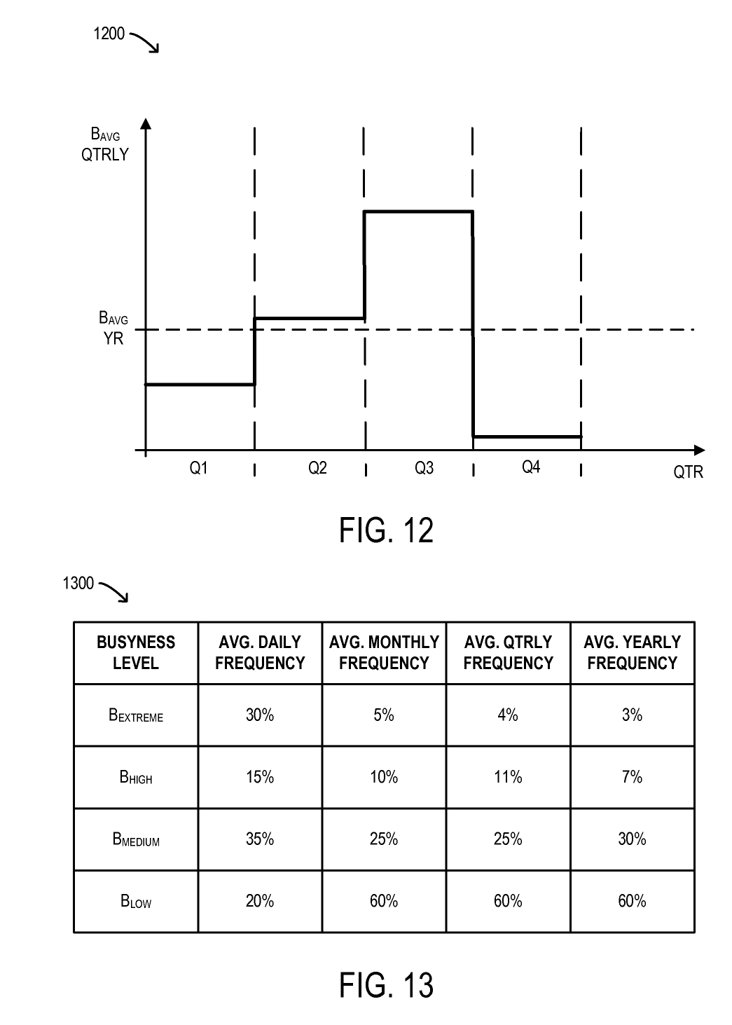

Referring to FIG. 12, an example graph 1200 according to some embodiments is shown. As shown on the graph 1200, the busyness level may be averaged over a period of time, such as a quarter (or any other time period). In some embodiments, the premium may be adjusted with the change in busyness level for that time period. In that case, as the busyness increases, the premium may increase, and when the busyness decreases, the premium may decrease. The amount of premium adjustment for a given time period may be based in part on the extent of influence the busyness level (or factor) has on the premium for a given time period. For example, in the winter the busyness level may have a greater influence on premiums in the northern states where ice and snow occurs, as the risk of a slip and fall may be greater. To determine the busyness level over a period of time, the mean (average, weighted or non-weighted, rolling or non-rolling), median, mode or any other technique may be used. Also the frequency at which the premium is adjusted due to busyness level (historical, current or predicted) may be set by the insurance company or selected by the customer/insured (e.g., in an on-line and/or mobile device selectable application).

Referring to FIG. 13, an example table 1300 according to some embodiments is shown. As shown in the table 1300, the busyness level may also be viewed in terms of frequency or percentage of overall time. For example, the percentage of time during business operating hours that the busyness level is extreme, high, medium and low over a period of time (e.g., daily, monthly, quarterly, yearly) may factor into the calculation of the busyness level for an object from a risk assessment standpoint. When viewed on a daily basis, the busyness level may appear high; however, when viewed over a yearly basis the busyness may appear much lower, due to averaging or other affects.

Turning to FIG. 14, an example interface 1400 according to some embodiments is shown. In some embodiments, the interface 1400 may be generated and/or presented (e.g., output) by a device such as the insurance device 120a, the shopping device 120b, the navigation device 120c, the advertising device 120d, the prioritization device 120e, and/or the other busyness device 120f of the system 100 of FIG. 1 and/or the subscriber device 592 and/or customer device 594 of the system 500 of FIG. 5 herein. The interface 1400 may, for example, comprise a map 1410 such as may be provided by a mapping application, website, navigational device, and/or software such as Google® maps provided by Google®, Inc. of Mountain View, Calif. and/or TomTom® International with U.S. headquarters in Concord, Mass. In some embodiments, the interface 1400 may be utilized by an insurance customer via an electronic device such as a portable telephone (or smart phone), PDA, and/or portable computer (such as a laptop, an iPAD™ or other similar device). The customer may download an application provided by the customer's insurance provider, for example, login and/or enter the customer's insurance policy number(s) or other access code, and access the busyness interface 1400 and/or busyness map 1410 thereof (e.g., for navigational purposes—such as for planning a trip that reduces risk exposure and/or reduces insurance premiums, and/or for obtaining general information about the busyness of a certain route or area). In some embodiments, for internet navigational software or navigational devices, the user may be able to unlock the “busyness” application by indicating that the user is insured by a certain insurance company and entering the policy number or other access code provided to the user by the insurance company (or third party). In that case, only users insured by certain insurance companies may access the busyness application and there may be a special sign-in window or icon with the insurance company name on the screen or accessible from a menu or tab. In other embodiments, the application may be made available for purchase by users who are not insurance customers.

As depicted in FIG. 14, map 1410 may comprise a navigational aid that facilitates a user traveling from the location marked “A” to the location marked “B”. As is typical with mapping and/or navigational tools, a recommended route 1412 between points A and B may be displayed. On the illustrated map 1410 the recommended route 1412 is indicated by shaded, elliptical marks. The route 1412 may, for example, be determined via a typical routing method such as “maximize highways”, “shortest time”, “shortest distance”, and/or a “direct” or “easy” route. In some embodiments, the routing method via which the route 1412 is determined may be based on busyness information, metrics, and/or indices.

The interface 1400 may, for example, include a busyness window 1420 via which a user of the interface 1400 may view (and/or otherwise access) data descriptive of busyness associated with the map 1410. As depicted in FIG. 14, for example, the busyness window 1420 may include selectable options 1422 operable to overlay on the map 1410 various data such as “historical”, “current” (which is the option selected for example purposes in FIG. 14), and/or “future” (e.g., predicted) busyness. As described herein, the busyness data may be descriptive of various busyness level (as described herein). For example, if there is a large number of vehicles (moving or standing still) on the road from A to B, the map will highlight the road in red (for high busyness).

In some embodiments, the busyness of a roadway (e.g., a transportation conduit object) may be represented in the map 1410 in a graphical manner to represent a total aggregate, minimum, average, and/or weighted busyness index or metric. The busyness window 1420 may, for example, comprise a key 1424 which in the example interface 1400 of FIG. 14 is descriptive of “high”, “moderate”, and “low” busyness. As depicted, for example, a first section 1426a of the roadway Interstate 84 (I-84) west of Hartford is currently experiencing “high” busyness, while a second section 1426b of Interstate 91 (I-91) south of Meriden is currently experiencing “low” busyness. According to some embodiments, depending on the type(s) of busyness represented by the map 1410, the indications of busyness may comprise objects other than roadway (or travel way) highlighting. For example, the busyness of an area or region may be represented by a highlighted region 1428, shown as a “moderate” busyness area in and around Manchester on the map 1410. In that example, there may be moderate busyness in the region 1428 due to many different reasons, such as a power outage, evacuation, a store being open late, a highly populated area, or any other reason that busyness may be high. In some embodiments, if the user touches the region 1428 or hovers over the region with a mouse, more detailed information regarding the reason(s) for the busyness rating may be displayed (e.g., vehicle density high, pedestrian density high, or any other description/reason for the busyness rating). In some embodiments, the trip routing method for the travel route 1412 may be based on one or more of these (and/or other) indications of busyness 1426a-b, 1428.

According to some embodiments for example, the interface 1400 may comprise a routing method window 1430. The routing method window 1430 may comprise selectable options 1432 which may, as depicted, be similar to the selectable options 1422 presented in the busyness window 1420. The selectable options 1432 may, in some embodiments, allow a user to select and/or set the desired time-frame for the routing method. As shown in the example of FIG. 14, the “future” option is selected and the time is set to three in the afternoon (3:00 PM). The routing method for the route 1412 may accordingly take into account expected “future” busyness in areas between and/or around A and B at three in the afternoon (3:00 PM), such as may be determined by predicting busyness based on historic busyness and/or other data recorded for such areas.

In some embodiments, the routing method window 1430 may comprise a plurality of busyness-based routing options 1434. The routing options may provide the “Least Busy” route, which would provide the route having the lowest level of busyness. Busyness data may be combined and/or analyzed together with typical roadway and/or travel data, for example, to allow the program underlying the interface 1400 to determine not only the “shortest” route from A to B, but the “Least Busy & Shortest” route, for example. As shown, the user may select the routing method to be a “Less Busy” route, a “Less Busy & Fastest” route, a “Less Busy & Shortest” route, an overall “Least Busy” route (discussed above), a “Least Busy & Fastest” route, and/or a “Least Busy & Shortest” route. The different busyness-based routing options 1434 are presented for exemplary purposes only. Fewer, more, and/or different busyness-based routing options may be presented to the user and/or may be utilized to determine the route 1412 in accordance with some embodiments.

As depicted in the example of FIG. 14, the “Least Busy & Fastest” option is selected. Thus, the route 1412 depicted on the map 1410 of the interface 1400 represents the determined fastest and least busy route from point A to point B, as predicted for three in the afternoon (3:00 PM). In some embodiments, such as to potentially obtain more accurate predictive results such as by taking into account daily, weekly, seasonal, and/or annual variations in recorded busyness data, the date of the future routing prediction may in some embodiments be specified (although it is not in the example of FIG. 14).

In some embodiments, such as in the case that one of the “Less Busy” routing methods is chosen, the routing method window 1430 may include a busyness selection/slider bar 1436 and/or a busyness slider/pointer 1438. The busyness selection bar 1436 may, for example, comprise a graphical icon of a bar representing a range of busyness values (e.g., metric and/or index values), from “Least Busy” to “Most Busy”. The busyness slider 1438 may, in some embodiments, represent the current and/or set value of busyness associated with the desired routing method. As shown, for example, the busyness slider 1438 is set slightly to the less-busy side of the middle of the busyness bar 1436. In some embodiments, the busyness represented by position of the busyness slider 1438 on the busyness bar 1436 may be represented by an indication of the actual value of the current and/or set or desired busyness (e.g., thirty five (35) as shown on the example busyness bar 1436, having an example range of zero (0) to one hundred (100)).

The busyness bar 1436 and the busyness slider 1438 may be utilized, for example, in the case that a “less busy” routing method is desired, such that the sliding and/or setting of the busyness slider 1438 may define the specific magnitude that corresponds to “less”; e.g., thirty five (35) in the example of FIG. 14. In some embodiments, the user may define their own route(s) and utilize the busyness bar 1436 and/or busyness slider 1438 to determine a busyness rating of the defined route. As the user slides the slider 1438, different routes from A to B may be highlighted indicating which routes meet the slider-selected busyness rating. This may be advantageous, for example, in the case that the user's insurance company offers reductions in insurance premiums for customers that conduct themselves within certain busyness thresholds.

An insurance company may offer tiered discounts and/or premium rate levels, for example, for customers who commit to (and/or who actually do) maintain certain busyness parameters within predetermined thresholds. In the case of travel, for example, trips planned and/or taken (e.g., monitored via GPS in an in-car navigational device and/or via the customer's mobile communications device) may be tallied with respect to various busyness ratings. Overall ratings in certain time periods (e.g., exposure to busyness per month) and/or a weighted busyness aggregate (e.g., frequency of experienced busyness levels) may, in some embodiments, be determined for individual customers. In the case that the tracked metrics fall within predetermined thresholds (e.g., an average experienced busyness of less than seventy-five (75) in any given month) the customer may qualify for a reduced premium, discount, and/or other reward (e.g., frequent flyer miles, reward points, and/or prizes; e.g., ten percent (10%) off monthly premium). In some embodiments, the user may obtain a certain number of points for certain busyness levels and gets a benefit if the user stays below (or above) a threshold number of points (over a set period of time). In some embodiments, the user may obtain benefits if user stays below (or above) a threshold percentage of trips having a certain busyness level (over a set period of time).

According to some embodiments, desired discount and/or insurance premium levels may be taken into account in the routing method for the route 1412. While not shown in FIG. 14, for example, the routing method options 1434 may include one or more options tied to insurance premium and/or discount levels such as “Maintain 10% Discount” or “Biggest Discount”. In such a manner, the routing method may facilitate the maintenance of the user's activities within the desired threshold ranges. In some embodiments, the busyness bar 1436 may represent a scale of insurance premiums and/or discounts, such as from “Lowest Premium” or “Biggest Discount” to “Highest Premium” or “Lowest Discount”. The user may then, for example, utilize the busyness slider 1438 to set or alter the routing method based on the effect that traveling any given route may have on the user's insurance premiums. In some embodiments, the user may enter a desired discount (name your “busyness” discount) or a desired premium (name your “busyness” premium) into a set-up screen (not shown) which may set the default busyness levels for suggested routes to obtain that discount or premium. The user may then move the slider from that point to select other possible routes if desired. The windows 1420 and 1430 may be mutually exclusive (only one may be used) or they may both be used. When both are used, the common fields (i.e., historical, current, future) may be required to have the same selection.

### III. Terms, Definitions and Rules of Interpretation

As utilized herein, the term “busyness data” may generally refer to a measure of activity of, through, in, or on an object (e.g., how “busy” the object is). Busyness data may include, but is not limited to, data descriptive of traffic conditions on roadways, data descriptive of foot traffic on sidewalks and/or in retail stores or entertainment venues, data descriptive of communication and/or data network traffic, and/or data descriptive of mechanical device utilization. Busyness data may, according to some embodiments, be categorized into one or more groups, classes, or types to define a “busyness parameter”. While busyness data descriptive of highway traffic may be gathered from a variety of sources (such as radar devices, pressure-sensitive devices, human observation, and/or cameras) and may be expressed in a variety of raw data terms (e.g., number of vehicles per hour, number of axles per hour, tonnage per hour), for example, all such data may be descriptive of a particular parameter, which in this example case, is the amount of traffic on a roadway.

Busyness parameters may, according to some embodiments, be utilized to define and/or formulate a “busyness index” (or busyness factor or busyness score). A busyness index may generally comprise a qualitative and/or quantitative scale, score, factor, or rank via which the magnitude of various busyness parameters may be analyzed. A busyness index for traffic congestion, for example, may comprise the qualitative six-letter (“A” through “F”) scale or Level of Service (LOS) as defined in the Highway Capacity Manual (HCM) published by the U.S. Transportation Research Board, and/or may comprise a numerically ranked scale from one (1) to one hundred (100), or any other numeric or alphanumeric range desired. As utilized herein, the term “busyness metric” may generally refer to any instance and/or type of busyness data, busyness parameter, and/or busyness index. Some embodiments herein for example, may utilize raw busyness data in processes, while some embodiments may utilize a combination of raw busyness data, busyness parameters, and/or busyness indices (e.g., to perform risk assessments and/or premium calculations). In some embodiments, the type of busyness metric employed may vary in time in accordance with desirability and/or practicality. In some embodiments, sub-busyness indices may be provided for (and based on) various aspects and/or types of busyness. Such sub-busyness indices may be or comprise separate and distinct indices, for example, or may be additive or otherwise cumulative as sub-parts of a more comprehensive and/or primary busyness index.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Definitions of various words, phrases, or the like may also appear elsewhere in this disclosure.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way the scope of the disclosed invention(s).

The term “product” or “system” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference”, unless expressly specified otherwise.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining an object associated with an insurance product;
determining, by a computerized processor, a busyness metric of the object; and
determining, by the computerized processor and based at least in part on the busyness metric of the object, a risk rating of the insurance product.

2. The method of claim 1, wherein the insurance product is configured to provide insurance coverage for something other than the object.

3. The method of claim 1, further comprising:
determining, by the computerized processor and based at least in part on the determined risk rating of the insurance product, an insurance premium of the insurance product.

4. The method of claim 3, further comprising:
receiving an indication of a request by a customer to purchase the insurance product; and
selling, after the determining of the insurance premium of the insurance product, the insurance product to the customer.

5. The method of claim 4, wherein the object is determined based on historic location data of the customer.

6. The method of claim 4, wherein the object is determined based on predicted location data of the customer.

7. The method of claim 4, further comprising:
determining, after the selling of the insurance product to the customer, a claim made on the insurance product.

8. The method of claim 7, further comprising:
determining, after the determining of the claim made on the insurance product, a value of a busyness parameter that is associated with the claim made on the insurance product.

9. The method of claim 8, further comprising:
updating, based on the value of the busyness parameter that is associated with the claim made on the insurance product, the busyness metric of the object.

10. The method of claim 8, further comprising:
updating, based on the value of the busyness parameter that is associated with the claim made on the insurance product, the risk rating of the insurance product.

11. The method of claim 10, further comprising:
updating, based on the value of the busyness parameter that is associated with the claim made on the insurance product, the insurance premium of the insurance product.

12. The method of claim 1, wherein the object comprises a transportation conduit object comprising one or more of: (i) a path or trail, (ii) a sidewalk, (iii) a road, (iv) an intersection of two or more roads, (v) a water channel, (vi) an High Occupancy Vehicle (HOV) lane of a road, (vii) a slow vehicle lane of a road, (viii) an exit lane or ramp of a road, (ix) an entrance ramp, lane, or merge area of a road, and (x) a railroad crossing.

13. The method of claim 1, wherein the object comprises a location object comprising one or more of: (i) a business location, (ii) a parking lot, (iii) a parking garage, (iv) a retail store, (v) a doctor's office, (vi) a bank, (vii) a mall, (viii) a hairdresser or barber shop, (ix) a restaurant, (x) a supermarket, (xi) a convenience store, (xii) a marina, (xiii) a train or bus station, (xiv) a bridge, (xv) a tunnel, (xvi) an airport, (xvii) a toll booth or plaza, (xviii) a dock, (ix) a ferry, (xx) public or municipal building, (xxi) a historic site or building, (xxii) a public landmark, (xxiii) a hospital, (xxiv) a library, (xxv) a museum, (xxvi) a national or state park, (xxvii) a public beach, (xxviii) a town square or green, (xxix) a public fairground, (xxx) a theatre, (xxxi) a sports facility, (xxxii) a racetrack, (xxxiii) an amusement park, (xxxiv) an arcade, (xxxv) a beach, (xxxvi) a resort, (xxxvii) a nightclub, (xxxviii) a golf course, and (xxxix) a casino.

14. The method of claim 1, wherein the object comprises a communication conduit object comprising one or more of: (i) a communication network, (ii) a website, (iii) an Internet Service Provider (ISP), (iv) a telephone queue, (v) an Interactive Voice Response Unit (IVRU) queue, and (vi) a cellular telephone network.

15. The method of claim 1, wherein the object comprises a mechanical object comprising one or more of: (i) a car; (ii) a motorcycle; (iii) a train, (iv) a bus, (v) an elevator, (vi) an escalator, (vii) a drawbridge, (viii) a water transport lock, (ix) a security lock, (x) a cellular telephone network tower or repeater, (xi) a router, (xii) a web server, (xiii) a file server, (xiv) an IVRU, (xv) a railroad crossing warning signal or gate, (xvi) a street light, and (xvii) a traffic light.

16. The method of claim 1, wherein the computerized processor comprises a computer system of an insurance company.

17. The method of claim 1, wherein the busyness metric is determined by:
transmitting information indicative of the object to a server storing historical information descriptive of the busyness associated with the object; and
receiving, from the server, one or more numerical values that define the busyness metric.

18. The method of claim 1, wherein the determining of the busyness metric, comprises:
storing data descriptive of at least one of historical information descriptive of the busyness associated with the object and predicted information descriptive of the busyness associated with the object;
analyzing the stored data; and
calculating, based on the analysis of the stored data, the busyness metric.

19. An apparatus, comprising:
a processor; and
a memory in communication with the processor, the memory storing instructions that when executed by the processor result in:
receiving an indication of a request by a customer for an insurance product;
determining an object indicative of risk associated with the insurance product;
determining a busyness metric of the risk indicative object; and
determining, based at least in part on the busyness metric, a risk rating of the insurance product.

20. An article of manufacture comprising a computer-readable memory storing instructions that when executed by a processor result in:
receiving an indication of a request by a customer for an insurance product;
determining an object indicative of risk associated with the insurance product;
determining a busyness metric of the risk indicative object; and
determining, based at least in part on the busyness metric, a risk rating of the insurance product.
